(19) United States
(12) Patent Application Publication
(10) Pub. No.: US 2023/0106223 A1
(43) Pub. Date: Apr. 6, 2023

(54) MOISTURE-CURABLE NON-YELLOWING CLEAR COMPOSITION AND METHOD OF MAKING THEREOFROM

(71) Applicant: MOMENTIVE PERFORMANCE MATERIALS INC., Waterford, NY (US)

(72) Inventors: Misty HUANG, New City, NY (US); Bruce BARBERA, Sleepy Hollow, NY (US)

(21) Appl. No.: 17/795,702

(22) PCT Filed: Jan. 21, 2021
(86) PCT No.: PCT/US2021/014272

§ 371 Date: Jul. 27, 2022

Related U.S. Application Data
(60) Provisional application No. 62/969,860, filed on Feb. 4, 2020.

(51) Int. Cl. C08G 77/458; C08G 18/48; C08G 18/75; C08G 18/24; C08G 18/83; C08K 5/3475; C08K 5/20; C08K 5/3435; C09J 183/10; C09J 11/06

(52) U.S. Cl. CPC C08G 77/458; C08G 18/4825; C08G 18/755; C08G 18/246; C08G 18/837; C08K 5/3475; C08K 5/20; C08K 5/3435; C09J 183/10; C09J 11/06; C08G 2170/80; C08K 2201/014

(57) ABSTRACT

There is provided herein a clear, transparent, low yellow color and non-yellowing moisture-curable silylated polymer composition, which contains an alkoxysilyl-containing polymer, a light stabilizer, a sterically hindered amine, a silicon compound containing a conjugated C═C group, an adhesion promoter and curing catalyst. There is also provide a method of making the moisture-curable composition and a sealant comprising the same.

### CROSS-REFERENCE TO RELATED APPLICATIONS

This application claims priority from U.S. Application Ser. No. 62/969,860, filed Feb. 4, 2020, the entire contents of which are incorporated herein by reference.

### FIELD OF THE INVENTION

This invention relates to moisture-curable alkoxysilyl-containing polymer compositions which are clear, transparent, low yellow color and non-yellowing and exhibit good adhesion to a variety of different substrates. The inventive alkoxysilyl-containing polymer compositions can be used in formulating coatings, adhesives or sealants in industrial and consumer applications, including construction, electronics, marine and transportation.

### BACKGROUND OF THE INVENTION

In the field of silicon-containing sealants and adhesives, various formulations are desired to be transparent (optically clear) and of low yellow color and to have good adhesion to various substrates. The color and transparency of these sealant materials can be negatively affected over time due to exposure of these materials, after application, to ultra-violet light, especially by exposure to sunlight.

Transparent moisture-curable silylated polyurethanes or silylated polyethers having good adhesion to various plastic, ceramic or metal substrates and of low yellow color are difficult to prepare. Many of these silane-containing polyurethanes and silylated polyethers employed in sealants, coating or adhesives are composed of polyether backbones. Polyethers may undergo degradation reactions when exposure to ultraviolet light (radiation) and oxygen in the air. To protect the polyether moieties from exposure to ultraviolent light, UV absorbers and stabilizers are used in the sealant, adhesive or coating compositions. Good adhesion to various ceramic and metal substrates can be achieved by using adhesion promoters, especially amino-functional alkoxysilanes. However, many common classes of UV absorbers and amino-functional alkoxysilane adhesion promoters become discolored after preparation and when in use. Benzophenols, benzotriazoles, salicylates, substituted tolyl compounds and metal chelate UV absorbers in combination with amino-functional alkoxysilane adhesion promoter discolor during storage of composition containing these additives. Benzotriazole derivatives often are yellow in color, further adding to the discoloration of the compositions.

Many benzotriazole-type UV absorbers are liquids, which makes them easy to incorporate into adhesive, sealant and coating compositions. However, when a curing catalyst, in particularly metal catalysts or metal catalysts in combination with amines, is used, the compositions typically yellow in the first few weeks or months after exposure to ultraviolet light. While not wishing to be bound to theory, this yellowing is believed to be due to an interaction of the benzotriazole UV absorber and the metal catalyst present in the sealant formulations.

While there has been an effort to substitute benzotriazole type UV absorbers with oxaldianilide UV absorbers in silylated prepolymer-based clear sealants, these oxaldianilide types of UV absorbers are only available in solid form and compositions containing these additives may discolor on exposure to ultraviolent light. In order to achieve good dispersion in the moisture-curable compositions, solid additives such as UV absorbers are often heated in solvent or plasticizer, prior to their introduction to the kettle, in order to effectively incorporate them into moisture-curable compositions, or alternatively, they may be melted in situ during the production by heating the mixer up to a temperature of 100° C. or higher. These methods for better dispersing the additives are inefficient and increase processing costs due to longer kettle residence times, less active materials in the kettle and consumption of more energy.

Accordingly, there remains a need to provide moisture-curable silylated polymer compositions which are clear, transparent, low yellow color and non-yellowing when exposed to ultraviolet light (radiation) in the presence of air and which have good adhesion to a variety of different substrates.

### SUMMARY OF THE INVENTION

The present invention relates to moisture curable silylated polymer compositions which are clear, transparent, low yellow color and non-yellowing and adhere to a variety of different substrates.

The current invention overcomes the aforementioned drawbacks by employing a silicon-compound having a conjugated structure which allows for the use of UV absorbers in the moisture-curable silylated polymer compositions and enables these compositions to be clear, transparent, have low yellow color and non-yellowing, especially on exposure to ultraviolet light (radiation) and air and which have good adhesion. In one aspect, the compositions are liquid compounds, which require less energy and shorter batch times during the composition preparation, which can lead to reductions in processing costs.

In another aspect, the invention relates to a clear, transparent, low yellow color and non-yellowing moisture-curable silylated polymer composition comprising:

(a) an alkoxysilyl-containing polymer having the general formula (I):

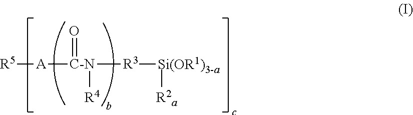

wherein

each A is independently —O— or —N(R⁴)—;

each R¹ is independently a straight chain alkyl group of from 1 to 4 carbon atoms or a branched chain alkyl group of from 3 to 4 carbon atoms;

each R² is independently methyl or phenyl:

each R³ is independently a straight chain alkylene group of from 1 to 6 carbon atoms or a branched chain alkylene group of from 3 to 6 carbon atoms;

each R⁴ is independently hydrogen, a straight chain alkyl group of from 1 to 6 carbon atoms, a branched chain alkyl group of from 3 to 6 carbon atoms, a cycloalkyl group of from 5 to 8 carbon atoms, a phenyl group or a —R³—Si(R²)ₐ(OR¹)₃₋ₐ group;

R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is independently a straight chain alkylene group of from 2 to 6 carbon atoms, a branched chain alkylene group of from 3 to 6 carbon atoms or a —C(═O)NH—R⁰—NHC(═O)— group, where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms, each R⁷ is independently a straight chain alkylene group of from 2 to 6 carbon atoms or a branched chain alkylene group of from 3 to 6 carbon atoms, each R⁸ is

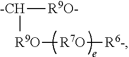

wherein each R⁹ is independently a straight chain alkylene group of from 1 to 5 carbon atoms or a branched chain alkylene group of from 3 to 5 carbon atoms; and the subscripts a, b, c, d, e and m are integers where each a is independently 0 or 1, b is 0 or 1, c is 2 or 3, each d is independently from 20 to 400, each e is independently from 0 to 100 and m is 0 or 1, with the provisos that if R⁶ is —C(═O)NH—R⁰—NHC(═O)— group, then A is —N(R⁴)— and b is 0;

(b) a UV light stabilizer package comprising:
(i) at least one light stabilizer having the formula (III):

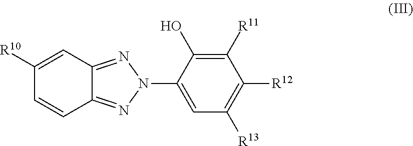

wherein

R¹⁰ is hydrogen or chloro;

R¹¹ is hydrogen, a straight chain alkyl group of from 1 to 12 carbon atoms, a branched chain alkyl group of from 3 to 12 carbon atoms, a

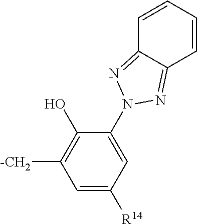

group, where R¹⁴ is a straight chain alkyl group of from 1 to 12 carbon atom or a branched chain alkyl group of from 3 to 12 carbon atoms, or an —OR¹⁵ group, where R¹⁵ is a straight chain alkyl group of from 1 to 12 carbon atoms or a branched chain alkyl group of from 3 to 12 carbon atoms;

R¹² is hydrogen, a straight chain alkyl group of from 1 to 12 carbon atoms, a branched chain alkyl group of from 3 to 12 carbon atoms or an —OR¹⁶ group, where R¹⁶ is a straight chain alkyl group of from 1 to 12 carbon atoms or a branched chain alkyl group of from 3 to 12 carbon atoms;

R¹³ is hydrogen, a straight chain alkyl group of from 1 to 12 carbon atoms, a branched chain alkyl group of from 3 to 12 carbon atoms, an —OR³⁹ group, where R³⁹ is a straight chain alkyl group of from 1 to 12 carbon atoms or a branched chain alkyl group of from 3 to 12 carbon atoms or a —(CH₂)_{f}C(═O)O(C_{g}H_{2g}O)ₕR¹⁷, where R¹⁷ is hydrogen, a straight chain alkyl group of from 1 to 12 carbon atoms, a branched chain alkyl group of from 3 to 12 carbon atoms or a group of formula (IV):

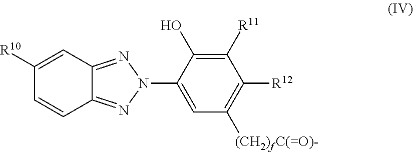

with the proviso that when R¹⁷ is the group of formula (IV), then h is 1 to 15; and

the subscripts f, g and h are integers where f is from 0 to 6, g is from 2 to 4 and h is from 0 to 15; or a light stabilizer having the formula (V):

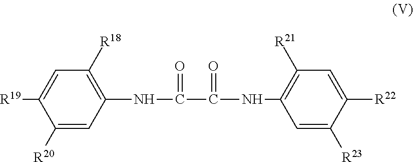

where each R¹⁸, R¹⁹, R²⁰, R²¹, R²² and R²³ is independently hydrogen, a straight chain alkyl group of from 1 to 16 carbon atoms, a branched chain alkyl group of from 3 to 16 carbon atoms or an —OR²⁴, where each R²⁴ is independently a straight chain alkyl group of from 1 to 16 carbon atoms or a branched chain alkyl group of from 3 to 16 carbon atoms;
(ii) at least one sterically hindered amine compound having the formula (VI):

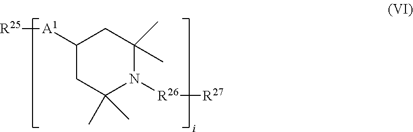

wherein

each A¹ is independently selected from the group consisting of straight chain alkenylene groups of from 1 to 10 carbon atoms, branched chain alkylene groups of from 3 to 10 carbon atoms or a chemical single bond;

each R²⁵ and R²⁷ is independently hydrogen, a straight chain alkyl group of 1 to 10 carbon atoms, a branched chain alkyl group of from 3 to 10 carbon atoms, a hydroxyl group, an amino group, —NR³⁸₂, where R³⁸ is independently hydrogen, a straight chain alkyl group of from 1 to 6 carbon atoms or a branched chain alkyl group of from 3 to 6 carbon atoms;

each R²⁶ is independently a straight chain alkylene group of from 1 to 10 carbon atoms, a branched chain alkylene group of from 3 to 10 carbon atoms, arylene group of from 6 to 10 carbon atoms, aralkylene group of 7 to 10 carbon atoms or a divalent organic group of 1 to 20 carbon atoms containing at least one divalent oxygen atoms forming an ether group, a —C(═O)O— group forming an ester functional group, carbonyl group, a primary amido group, a secondary amido group, a primary amino group, a secondary amino group or tertiary amino group; and

the subscript i is an integer from 1 to 100; or sterically hindered amine compound having the formula (VII):

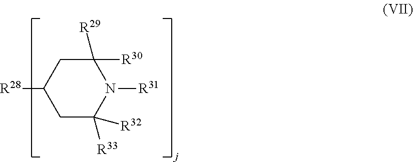

wherein

R²⁸ is hydrogen, a monovalent or polyvalent hydrocarbon group containing from 1 to 16 carbon atoms, a monovalent or polyvalent organic group of from 1 to 24 carbon atoms containing at least one triazinyl group, pyrimidinyl group, pyridinyl group, 2,4,6-trione-1,3,5-triazinyl group, divalent oxygen atoms forming an ether group, a —C(═O)O— group forming an ester functional group, carbonyl group, a primary amido group or secondary amido group, a primary amino group, a secondary amino group or tertiary amino group;

each R²⁹, R³⁰, R³² and R³³ is independently a straight chain alkyl group of from 1 to 6 carbon atoms or a branched chain alkyl group of from 3 to 6 carbon atoms;

each R³¹ is independently hydrogen, a straight chain alkyl group of from 1 to 10 carbon atoms, a branched chain alkyl group of from 3 to 10 carbon atoms, an aryl group of from 6 to 10 carbon atom or an aralkyl of from 7 to 10 carbon atoms; and

the subscript j is an integer from 1 to 5.
(iii) a silicon compound containing a conjugated C═C group having the general formula (VIII):

A²Si(CH₃)ₖ(OR³⁵)₃₋ₖ (VIII)

wherein

A² is CH₂═C(CH₃)C(═O)OCH₂CH₂CH₂— or phenyl;

R³⁵ is independently a straight chain alkyl group of from 1 to 4 carbon atoms or a branched chain alkyl group of 3 or 4 carbon atoms; and

k is an integer 0 or 1;

(c) an adhesion promoter containing an alkoxysilyl group; and

(d) a curing catalyst.

There is also provided herein a method of making a clear, transparent, low yellow color and non-yellowing moisture curable composition comprising mixing an alkoxysilyl-containing polymer (a), a UV light stabilizer package (b), an adhesion promoter (c) and curing catalyst (d).

### DETAILED DESCRIPTION OF THE INVENTION

The inventors herein have unexpectedly discovered that the incorporation of a silicon compound having a conjugated C═C group into a UV light stabilizer package further comprising a light stabilizer and a sterically hindered amine generated a synergistic affect in which the color of a moisture curable alkoxysilyl-containing composition was reduced upon exposure to ultraviolet light (radiation) and thereby reduced or eliminated yellowing of the composition when exposed to environmental conditions, such as air and sunlight. Therefore, the composition provided herein can provide the desired non-yellowing properties to a clear, transparent and low yellow color moisture-curable alkoxysilyl-containing polymer composition, thereby making these clear and transparent compositions suitable for many industrial and consumer adhesives, sealants and coatings.

In the specification and claims herein, the following terms and expressions are to be understood as indicated.

As used herein, “yellowing” refers to an increase in the intensity of the color in the yellow region of the visible light spectrum of a moisture curable alkoxysilyl-containing composition when stored in its container or applied to a substrate, cured and exposed to environmental conditions, especially air and ultraviolet radiation. The color in the yellow region of the visible light spectrum has a wavelength of from 560 nanometers to 590 nanometers. The International Commission on Illumination (French Commission internationale de l'éclairage) define the color space, CIE 1976 L*a*b* color space, which is used for measuring object colors. CIELAB colors are defined relative to the white point of the CIEXYZ space from which they were converted. CIELAB values do not define absolute colors unless the white point is also specified. The white point is a standard and the International Color Consortium L*A*b* are relative to CIE standard illuminate D50 as defined by CIE in 1976 for color communication and is widely adopted today in many industries for color control and management. In the L*a*b* color space, L* indicates lightness and a* and b* are chromaticity coordinates. a* and b* are color directions: +a* is the red axis, −a′ is the green axis, +b* is the yellow axis and −b* is the blue axis.

The extent of “yellowing” is determined by measuring the amount of increase in the +b* direction of the color before and after exposure to a Xenon-arc lamps in a Q-Sun Xenon test chamber according to ISO 4892-2:2013 Annex B Method B cycle B7 for 7 days. The specimens were tested using DIE-LAB by Minolta colorimeter (L*a*b*). The Minolta white calibration plate has a b* value of 4.25. The cured clear composition sheet was placed on the top of white calibration plate to measure the color. The b value was recorded and compared before and after exposure in Xenon test chamber.

As used herein, “transparency” is the physical property of allowing light to pass through a material without being scattered. The total transmittance is the ratio of transmitted light to the incident light. The transparency of the composition is determined by measuring the haze, in accordance with ASTM D-1003-Standard Test Method for Haze and Luminous Transmittance of Transparent Plastics.

As used herein, “clear” means a composition's transparency to light, as determined in accordance with ASTM D-1003-Standard Test Method for Haze and Luminous Transmittance of Transparent Plastics.

As used herein, “haze” is a measure of the cloudy appearance in a transparent solid as determined in accordance with ASTM D-1003-Standard Test Method for Haze and Luminous Transmittance of Transparent Plastics.

As used herein, “non-yellowing” refers to no positive increase in the b* value of the composition after exposure to a Xenon-arc lamps in a Q-Sun Xenon test chamber according to ISO 4892-2:2013 Annex B Method B cycle B7 for 7 days.

The singular forms “a,” “an,” and “the” include the plural, and reference to a particular numerical value includes at least that particular value, unless the context clearly dictates otherwise.

Other than in the working examples or where otherwise indicated, all numbers expressing amounts of materials, reaction conditions, time durations, quantified properties of materials, and so forth, stated in the specification and claims are to be understood as being modified in all instances by the term “about”.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

The terms, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

It will be understood that any numerical range recited herein includes all sub-ranges within that range and any combination of the various endpoints of such ranges or sub-ranges, be it described in the examples or anywhere else in the specification.

As used herein, integer values of stoichiometric subscripts refer to molecular species and non-integer values of stoichiometric subscripts refer to a mixture of molecular species on a molecular weight average basis, a number average basis or a mole fraction basis.

In the description that follows, all weight percentages are based upon total weight percent of the organic material(s) unless stated otherwise and all ranges given herein comprise all subranges therebetween and any combination of ranges and/or subranges therebetween.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

As used herein, the expression “hydrocarbon group” or “hydrocarbon radical” means any hydrocarbon composed of hydrogen and carbon atoms from which one or more hydrogen atoms has been removed and is inclusive of alkyl, alkenyl, alkynyl, cycloalkyl, cycloalkenyl, cycloalkynyl, aryl, aralkyl and arenyl groups. Groups can be composed of hydrocarbon groups containing at least one heteroatom and more specifically, a hydrocarbon group containing at least one heteroatom of oxygen, nitrogen or sulfur.

As used herein, the term “alkyl” means any monovalent, saturated straight chain or branched chain hydrocarbon group in which one hydrogen atom has been removed; the term “alkenyl” means any monovalent straight chain or branched chain hydrocarbon group containing one or more carbon-carbon double bonds where the site of attachment of the group can be either at a carbon-carbon double bond or elsewhere therein; and, the term “alkynyl” means any monovalent straight chain or branched chain hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein; the term “aryl” means an aromatic hydrocarbon in which one hydrogen atom has been removed; the term, aralkyl” means a hydrocarbon composed of both are aryl group and an alkyl group in which one hydrogen atom has been removed. Representative and non-limiting examples of alkyl groups include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl. An example of aryl is phenyl. Examples of aralkyl include benzyl and phenethyl.

As used herein, the term “alkylene” mean any divalent, saturated straight chain or branched chain hydrocarbon group in which two hydrogen atoms have been removed. Examples of alkylene groups include methylene (—CH₂—), ethylene (—CH₂CH₂—), propylene (—CH₂CH₂CH₂—) and 2-methylpropylene (—CH₂CH(CH₃)CH₂—). It is to be understood that in naming a compound, it is common nomenclature usage to use the name for the divalent alkyl group, which is an alkyl group where one addition hydrogen has been removed, in the name, such as 3-aminopropyltrimethoxysilane, where propyl is a divalent alkyl group and equivalent to propylene. The term “arylene” refers to a cyclic aromatic hydrocarbon in which two hydrogen atoms have been removed.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C).

It will be understood herein that the repeat unit (R⁸O)— can be at any position along the polymer chain group (R⁷O)_{d}(R⁸O)_{c-2}, including at the beginning of the polymer chain group, at the end of the polymer chain group or at any position between the beginning and end of the polymer chain group.

It will also be understood herein that any of the components of the invention herein as they are described by any specific genus or species detailed in the examples section of the specification, can be used in one embodiment to define an alternative respective definition of any endpoint of a range elsewhere described in the specification with regard to that component, and can thus, in one non-limiting embodiment, be used to supplant such a range endpoint, elsewhere described.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The present invention relates to a moisture-curable silylated polymer composition comprising:

(a) an alkoxysilyl-containing polymer having the general formula (I):

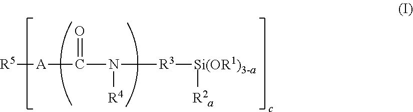

wherein

each A is independently —O— or —N(R⁴);

each R¹ is independently a straight chain alkyl group of from 1 to 4 carbon atoms or a branched chain alkyl group of from 3 to 4 carbon atoms;

each R² is independently methyl or phenyl:

each R³ is independently a straight chain alkylene group of from 1 to 6 carbon atoms or a branched chain alkylene group of from 3 to 6 carbon atoms;

each R⁴ is independently hydrogen, a straight chain alkyl group of from 1 to 6 carbon atoms, a branched chain alkyl group of from 3 to 6 carbon atoms, a cycloalkyl group of from 5 to 8 carbon atoms, a phenyl group or a —R³—Si(R²)ₐ(OR¹)₃₋ₐ group;

R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is independently a straight chain alkylene group of from 2 to 6 carbon atoms, a branched chain alkylene group of from 3 to 6 carbon atoms or a —C(═O)NH—R⁰—NHC(═O)— group, where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms, each R⁷ is independently a straight chain alkylene group of from 2 to 6 carbon atoms or a branched chain alkylene group of from 3 to 6 carbon atoms, each R⁸ is

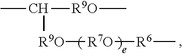

wherein each R⁹ is independently a straight chain alkylene group of from 1 to 5 carbon atoms or a branched chain alkylene group of from 3 to 5 carbon atoms; and the subscripts a, b, c, d, e and m are integers where each a is independently 0 or 1, b is 0 or 1, c is 2 or 3, each d is independently from 20 to 400, each e is independently from 0 to 100 and m is 0 or 1, with the provisos that if R⁶ is —C(═O)NH—R⁰—NHC(═O)— group, then A is —N(R⁴)— and b is 0;

(b) a UV light stabilizer package comprising:
(i) at least one light stabilizer having the formula (III):

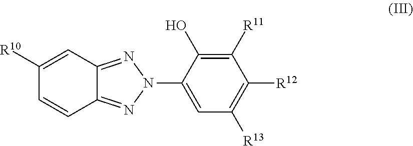

wherein

R¹⁰ is hydrogen or chloro;

R¹¹ is hydrogen, a straight chain alkyl group of from 1 to 12 carbon atoms, a branched chain alkyl group of from 3 to 12 carbon atoms, a

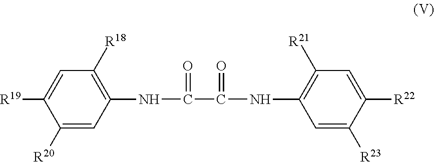

group, where R¹⁴ is a straight chain alkyl group of from 1 to 12 carbon atom or a branched chain alkyl group of from 3 to 12 carbon atoms, or an —OR¹⁵ group, where R¹⁵ is a straight chain alkyl group of from 1 to 12 carbon atoms or a branched chain alkyl group of from 3 to 12 carbon atoms;

R¹² is hydrogen, a straight chain alkyl group of from 1 to 12 carbon atoms, a branched chain alkyl group of from 3 to 12 carbon atoms or an —OR¹⁶ group, where R¹⁶ is a straight chain alkyl group of from 1 to 12 carbon atoms or a branched chain alkyl group of from 3 to 12 carbon atoms;

R¹³ is hydrogen, a straight chain alkyl group of from 1 to 12 carbon atoms, a branched chain alkyl group of from 3 to 12 carbon atoms, an —OR³⁹ group, where R³⁹ is a straight chain alkyl group of from 1 to 12 carbon atoms or a branched chain alkyl group of from 3 to 12 carbon atoms, or a —(CH₂)_{f}C(═O)O(C_{g}H_{2g}O)ₕR¹⁷, where R¹⁷ is hydrogen, a straight chain alkyl group of from 1 to 12 carbon atoms, a branched chain alkyl group of from 3 to 12 carbon atoms or a group of formula (IV):

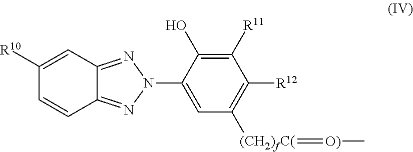

with the proviso that when R¹⁷ is the group of formula (IV), then h is 1 to 15; and

the subscripts f, g and h are integers where f is from 0 to 6, g is from 2 to 4 and h is from 0 to 15; or a light stabilizer having the formula (V):

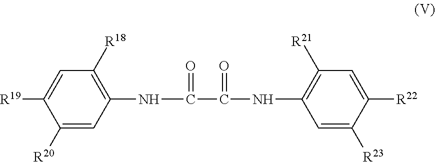

where each R¹⁸, R¹⁹, R²⁰, R²¹, R²² and R²³ is independently hydrogen, a straight chain alkyl group of from 1 to 16 carbon atoms, a branched chain alkyl group of from 3 to 16 carbon atoms or an —OR²⁴, where each R²⁴ is independently a straight chain alkyl group of from 1 to 16 carbon atoms or a branched chain alkyl group of from 3 to 16 carbon atoms;
(ii) at least one sterically hindered amine compound having the formula (VI):

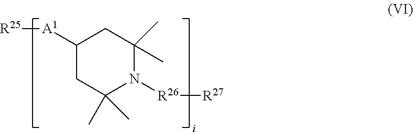

wherein

each A¹ is independently selected from the group consisting of straight chain alkenylene groups of from 1 to 10 carbon atoms, branched chain alkylene groups of from 3 to 10 carbon atoms or a chemical single bond;

each R²⁵ and R²⁷ is independently hydrogen, a straight chain alkyl group of 1 to 10 carbon atoms, a branched chain alkyl group of from 3 to 10 carbon atoms, a hydroxyl group, an amino group, —NR³⁸₂, where R³⁸ is independently hydrogen, a straight chain alkyl group of from 1 to 6 carbon atoms or a branched chain alkyl group of from 3 to 6 carbon atoms;

each R²⁶ is independently a straight chain alkylene group of from 1 to 10 carbon atoms, a branched chain alkylene group of from 3 to 10 carbon atoms, arylene group of from 6 to 10 carbon atoms, aralkylene group of 7 to 10 carbon atoms or a divalent organic group of 1 to 20 carbon atoms containing at least one divalent oxygen atoms forming an ether group, a —C(═O)O— group forming an ester functional group, carbonyl group, a primary amido group, a secondary amido group, a primary amino group, a secondary amino group or tertiary amino group; and

the subscript i is an integer from 1 to 100; or sterically hindered amine compound having the formula (VII):

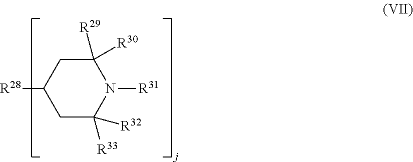

wherein

R²⁸ is hydrogen, a monovalent or polyvalent hydrocarbon group containing from 1 to 16 carbon atoms, a monovalent or polyvalent organic group of from 1 to 24 carbon atoms containing at least one triazinyl group, pyrimidinyl group, pyridinyl group, 2,4,6-trione-1,3,5-triazinyl group, divalent oxygen atoms forming an ether group, a —C(═O)O— group forming an ester functional group, carbonyl group, a primary amido group or secondary amido group, a primary amino group, a secondary amino group or tertiary amino group;

each R²⁹, R³⁰, R³² and R³³ is independently a straight chain alkyl group of from 1 to 6 carbon atoms or a branched chain alkyl group of from 3 to 6 carbon atoms;

each R³¹ is independently hydrogen, a straight chain alkyl group of from 1 to 10 carbon atoms, a branched chain alkyl group of from 3 to 10 carbon atoms, an aryl group of from 6 to 10 carbon atom or an aralkyl of from 7 to 10 carbon atoms; and

the subscript j is an integer from 1 to 5.
(iii) a silicon compound containing a conjugated C═C group having the general formula (VIII):

A²Si(CH₃)ₖ(OR³⁵)₃₋ₖ (VIII)

wherein

A² is CH₂═C(CH₃)C(═O)OCH₂CH₂CH₂— or phenyl;

R³⁵ is independently a straight chain alkyl group of from 1 to 4 carbon atoms or a branched chain alkyl group of 3 or 4 carbon atoms; and

k is an integer 0 or 1;

(c) an adhesion promoter containing an alkoxysilyl group; and

(d) a curing catalyst.

The alkoxysilyl-containing polymer composition is clear, transparent, low yellow color and non-yellowing.

In one embodiment herein, the alkoxysilyl-containing polymers (a) employed in the present invention are known materials and in general can be obtained by (i) reacting an isocyanate-containing polyurethane prepolymer (PUR) with a suitable silane, which possesses both alkoxysilyl functionality and an active hydrogen-containing functionality such as primary amine or secondary amine, preferably the latter, by (ii) reacting a hydroxyl-containing polyurethane prepolymer with a suitable isocyanate-containing silane possessing two or three alkoxy groups, by (iii) reaction of a hydroxyl-containing poly(oxyalkyene) polymer with an isocyanate-containing silane possessing two or three alkoxy groups, or by (iv) reaction of an allyl containing poly(oxyalkylene) polymer with a hydridoalkoxysilane. The details of these reactions, and those for preparing the isocyanate-containing and hydroxyl-containing polyurethane prepolymers employed therein are known to those of ordinary skill in the art.

The number average molecular weight, the weight average molecular weight and the polydispersivity of the alkoxysilyl-containing polymers (a) or polyols can be determined by ASTM D5296-11 Standard Test Method for Molecular Weight Averages and Molecular Weight Distribution of Polystyrene by High Performance Size-Exclusion Chromatograph.

Included among the polyols that can be utilized for the preparation of the alkoxysilyl-containing polymers (a) are hydroxyl-containing poly(oxyalkylene) polymers, also referred to as polyether polyols. In an embodiment, specific suitable polyether polyols are diols including poly(oxyethylene) diols, poly(oxypropylene) diols and the poly(oxyethylene-oxypropylene) diols and triols including poly(oxyethylene) triols, poly(oxypropylene) triols and the poly(oxyethylene-oxypropylene) triols. In one embodiment of the present invention, the polyols used in the production of the alkoxysilyl-containing polymer (a) are poly(oxyalkene) diols having number average molecular weights of from 500 grams/mole and 25,000 grams/mole. In another embodiment, the polyols used in the production of the alkoxysilyl-containing polymer (a) are poly(oxypropylene) diols having number average molecular weights from about 1,000 grams/mole to about 20,000 g/mole, more specifically from 8,000 grams/mole to 11,000 grams/mole. Mixtures of polyols of various structures, molecular weights and/or functionalities can also be used. The number average molecular weights of the polyols can be determined from the hydroxyl number and the functionality of the polyol. The hydroxyl number can be determined by ASTM D4274-05 Standard Test Methods for Testing Polyurethane Raw Materials: Determination of Hydroxyl Number of Polyols. The unsaturation of the polyol can be determined by ASTM D4671-16 Standard Test Methods for Polyurethane Raw Materials: Determination of Unsaturation of Polyols.

In an embodiment, the polyether polyols can have a hydroxyl functionality up to about 3, in another embodiment a hydroxyl functionality of from about 1.8 to 3 and in yet another embodiment a hydroxyl functionality of 1.95 to 2.0 (i.e., diols). Especially suitable are the polyether polyols prepared in the presence of double-metal cyanide (DMC) catalysts, an alkaline metal hydroxide catalyst, or an alkaline metal alkoxide catalyst, such as those which are known by those of ordinary skill in the art. Polyether polyols produced in the presence of such catalysts tend to have high molecular weights and low levels of unsaturation, properties of which, although not wishing to be bound by theory, it is believed are responsible for the improved performance of the cured compositions. The polyether polyols preferably have a number average molecular weight of from about 1,000 grams/mole to about 25,000 grams/mole, more preferably from about 2,000 grams/mole to about 20,000 grams/mole, and even more preferably from about 4,000 grams/mole to about 18,000 grams/mole. The polyether polyols preferably have an end group unsaturation level of no greater than about 0.04 milliequivalents per gram of polyol. More preferably, the polyether polyol has an end group unsaturation of no greater than about 0.02 milliequivalents per gram of polyol. Examples of commercially available diols that are suitable for making the isocyanate-terminate prepolymer include ARCOL R-1819 (number average molecular weight of 8,000), E-2204 (number average molecular weight of 4,000), and ARCOL E-2211 (number average molecular weight of 11,000).

In preparing the alkoxysilyl-containing polymer (a) by reaction (i), the isocyanate-containing polyurethane prepolymers are obtained by reacting one or more polyols, advantageously, diols, with one or more polyisocyanates, especially diisocyanates, in such proportions that the resulting prepolymers will be terminated with isocyanate groups. In the case of reacting a diol with a diisocyanate, a molar excess of diisocyanate will be employed.

In one embodiment, a diisocyanate is used after the reaction of the polyol with the polyisocyanate which has the general formula (IX):

R⁰(—N═C═O)₂ (IX)

wherein R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms.

According to an embodiment of the invention, isocyanate-containing prepolymer is prepared by reacting diisocyanates with polyols at a molar ratio of NCO to OH (NCO:OH) in a range from about 1.1:1 to about 2.0:1, more preferably from about 1.4:1 to about 1.9:1 and more preferably from about 1.5:1 to about 1.8:1.

In the preparation of isocyanate-containing polyurethane, numerous diisocyanates, and mixtures thereof, can be used to provide the isocyanate-containing polyurethane prepolymers. In one embodiment, the diisocyanate can be diphenylmethane diisocyanate (“MDI”), paraphenylene diisocyanate, naphthylene diisocyanate, liquid carbodiimide-modified MDI and derivatives thereof, isophorone diisocyanate, dicyclohexylmethane-4,4′-diisocyanate, toluene diisocyanate (“TDI”), particularly the 2,6-TDI isomer, as well as various other aliphatic and aromatic polyisocyanates that are well-established in the art, and combinations thereof.

A catalyst may be used in the preparation of the above-mentioned isocyanate-containing prepolymers. Suitable catalysts are metal salts or bases, and include the non-limiting examples of bismuth salts, such as bismuth trisneodecanoate and other bismuth carboxylates; zirconium compounds or aluminum compounds, such as zirconium chelates and aluminum chelates; dialkyltin dicarboxylates, such as dibutyltin dilaurate and dibutyltin acetate, tertiary amines, the stannous salts of carboxylic acids, such as stannous octoate and stannous acetate, and the like.

Advantageously, condensation catalysts are employed since these will also catalyze the cure (hydrolysis followed by crosslinking) of the alkoxysilyl-containing polymer (a) component of the curable compositions of the invention. Suitable condensation catalysts include the dialkyltin dicarboxylates such as dibutyltin dilaurate and dibutyltin acetate, tertiary amines, the stannous salts of carboxylic acids, such as stannous octoate and stannous acetate, and the like. In one embodiment of the present invention, dibutyltin dilaurate catalyst is used in the production of the polyurethane prepolymer. Other useful catalysts include zirconium complex KAT XC6212, K-KAT XC-A209 available from King Industries, Inc., aluminum chelate TYZER® types available from DuPont Company, and KR types available from Kenrich Petrochemical, Inc., and other organic metal, such as Zn, Co, Ni, and Fe, and the like.

In one embodiment, the amount of catalyst used in the preparation of the alkoxysilyl-containing polymer (a) is from 1 part per million (ppm) to about 1 weight percent, based on the weight of the polyol used, more specifically from 3 parts per million to 0.5 weight percent, and even more specifically from 15 parts per million to 0.2 weight percent.

The reaction can be conducted at ambient temperature to about 120° C. and more specifically, from 35° C. to about 80° C. and at pressures ranging from 100 Pa to 200,000 Pa, more specifically from 150 Pa to 120,000 Pa.

The reaction of the diisocyanate with the polyol provides for a hydroxyl-containing polymer having the general formula (X):

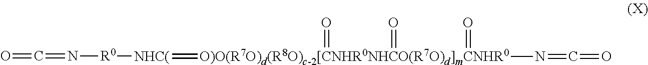

wherein where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms, each R⁷ is independently a straight chain alkylene group of from 2 to 6 carbon atoms or a branched chain alkylene group of from 3 to 6 carbon atoms, each R⁸ is

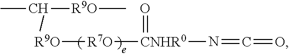

wherein each R⁹ is independently a straight chain alkylene group of from 1 to 5 carbon atoms or a branched chain alkylene group of from 3 to 5 carbon atoms; and the subscripts c, d, e and m are integers where c is 2 or 3, each d is independently from 20 to 400, each e is independently from 0 to 100 and m is 0 or 1.

Silylation reactants for reaction with the isocyanate-containing polyurethane prepolymers (X) described above contain functionality that is reactive with isocyanate and at least one readily hydrolyzable alkoxysilyl group, which upon hydrolysis to form silanols, can subsequently condense to form a siloxane group. Particularly useful silylation reactants are the amino-functional alkoxysilanes, especially those of the general formula (XI):

HN(R⁴)R³—Si(R²)ₐ(OR¹)₃₋ₐ (IX)

wherein

each R¹ is independently a straight chain alkyl group of from 1 to 4 carbon atoms or a branched chain alkyl group of from 3 to 4 carbon atoms;

each R² is independently methyl or phenyl:

each R³ is independently a straight chain alkylene group of from 1 to 6 carbon atoms or a branched chain alkylene group of from 3 to 6 carbon atoms;

each R⁴ is independently hydrogen or a straight chain alkyl group of from 1 to 6 carbon atoms, a branched chain alkyl group of from 3 to 6 carbon atoms, a cycloalkyl group of from 5 to 8 carbon atoms, a phenyl group or a —R³—Si(R²)ₐ(OR¹)₃₋ₐ group; and the subscript a is an integer, wherein a is 0 or 1.

The amount of amino-functional alkoxysilane used in the silylation of the isocyanate-containing polyurethane prepolymer can be less than stoichiometric amounts, stoichiometric amounts or more than stoichiometric amounts. The molar ratio of N—H to NCO (N—H:NCO) is from about 0.05:1 to about 2.0:1, preferably from about 0.9:1 to about 1.1:1 and even more preferably from about 0.95:1 to about 1.05:1.

In an embodiment, R¹ is methyl, R² is methyl, R³ is —CH₂CH₂CH₂—, —CH₂C(CH₃)₂CH₂CH₂— or —CH₂CH(CH₃)CH₂—, R⁴ is hydrogen, methyl, ethyl or phenyl and a is 0.

Representative and non-limiting examples of the amino-functional alkoxysilanes include 3-aminopropyltrimethoxysilane, 1-aminomethyltrimethoxysilane, 3-aminopropylmethyldimethoxysilane, aminomethylmethyldimethoxysilane, 3-aminopropyltriethoxysilane, N-methyl-3-aminopropyltrimethoxysilane, N-methyl-3-aminopropyltriethoxysilane, N-methyl-3-aminobutyltriethoxysilane, N-ethyl-3-aminopropylmethyldimethoxysilane, N-phenyl-3-aminopropyltrimethoxysilane, N-butyl-3-aminopropyltrimethoxysilane, N-cyclohexyl-3-aminopropyltrimethoxysilane, N-methyl-3-amino-2-methylpropyltriemthoxysilane, N-ethyl-3-amino-2-methylpropyltrimethoxysilane, N-ethyl-3-amino-2-methylpropyldiethoxysilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, N-ethyl-4-amino-3,3-dimethylbutyidimethoxymethylsilane and N-ethyl-4-amino-3,3-dimethylbutyltrimethoxysilane.

The reaction product from the reaction (i) has the general formula (I) wherein A is independently —N(R⁴); each R¹ is independently a straight chain alkyl group of from 1 to 4 carbon atoms or a branched chain alkyl group of from 3 to 4 carbon atoms; each R² is independently methyl or phenyl; each R³ is independently a straight chain alkylene group of from 1 to 6 carbon atoms or a branched chain alkylene group of from 3 to 6 carbon atoms; each R⁴ is independently hydrogen or a straight chain alkyl group of from 1 to 6 carbon atoms, a branched chain alkyl group of from 3 to 6 carbon atoms, a cycloalkyl group of from 5 to 8 carbon atoms, a phenyl group or a —R³—Si(R²)ₐ(OR¹)₃₋ₐ group; R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is a —C(═O)NH—R⁰—NHC(═O)— group, where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms, each R⁷ is independently a straight chain alkylene group of from 2 to 6 carbon atoms or a branched chain alkylene group of from 3 to 6 carbon, each R⁸ is

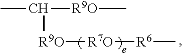

wherein each R⁹ is independently a straight chain alkylene group of from 1 to 5 carbon atoms or a branched chain alkylene group of from 3 to 5 carbon atoms; and the subscripts a, b, c, d, e and m are integers where each a is independently 0 or 1, b is 0, c is 2 or 3, each d is independently from 20 to 400, each e is independently from 0 to 100 and m is 0 or 1.

In one embodiment herein alkoxysilyl-containing polymer (a) can be prepared by the reaction (ii) of a hydroxyl-containing polyurethane prepolymer with an isocyanato-containing silane. The hydroxyl-containing polyurethane prepolymer can be obtained in substantially the same manner employing substantially the same materials, i.e., polyols, diisocyanates and optional catalysts (preferably condensation catalysts), described above for the preparation of isocyanate-containing prepolymers, the one major difference being that the proportions of polyol and diisocyanate will be such as to result in a prepolymer having hydroxyl groups.

According to one embodiment of the invention, hydroxyl-containing polyurethane prepolymer is prepared by reacting diisocyanates with polyols where the molar ratio of NCO to OH (NCO:OH) is in the range specifically from about 0.10:1 to about 0.99:1, more specifically from about 0.30:1 to about 0.95:1 and most specifically from about 0.50:1 to about 0:1.9.

The reaction can be conducted at ambient temperature to about 120° C. and more specifically, from 35° C. to about 80° C. and at pressures ranging from 100 Pa to 200,000 Pa, more specifically from 150 Pa to 120,000 Pa.

The reaction of the diisocyanate with the polyol provides for a hydroxyl-containing polyurethane polymer having the general formula (XII):

HO(R⁷O)_{d}(R⁸O)_{c-2}[C(═O)NHR⁰NHC(═O)O(R⁷O)_{d}]ₘH (XII)

wherein where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms, each R⁷ is independently a straight chain alkylene group of from 2 to 6 carbon atoms or a branched chain alkylene group of from 3 to 6 carbon atoms each R⁸ is

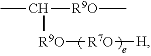

wherein each R⁹ is independently a straight chain alkylene group of from 1 to 5 carbon atoms or a branched chain alkylene group of from 3 to 5 carbon atoms; and the subscripts c, d, e and m are integers where, c is 2 or 3, each d is independently from 20 to 400, each e is independently from 0 to 100 and m is 0 or 1.

Useful silylation reactants for the hydroxyl-containing polyurethane polymers are those containing isocyanate termination and readily hydrolyzable functionality. Suitable silylating reactants are the isocyanatosilanes of the general formula (XIII):

O═C═N—R³—Si(R²)ₐ(OR¹)₃₋ₐ (XIII)

wherein

each R¹ is independently a straight chain alkyl group of from 1 to 4 carbon atoms or a branched chain alkyl group of from 3 to 4 carbon atoms;

each R² is independently methyl or phenyl:

each R³ is independently a straight chain alkylene group of from 1 to 6 carbon atoms or a branched chain alkylene group of from 3 to 6 carbon atoms; and

the subscript a is an integer, wherein a is 0 or 1.

Specific isocyanatosilanes that can be used herein to react with the foregoing hydroxyl-containing polyurethane prepolymers to provide alkoxysilyl-containing polymers (a) include isocyanatopropyltrimethoxysilane, isocyanatoisopropyl trimethoxysilane, isocyanato-n-butyltrimethoxysilane, isocyanato-t-butyltrimethoxysilane, isocyanatopropyltriethoxysilane, isocyanatoisopropyltriethoxysilane, isocyanato-n-butyltriethoxysilane, isocyanato-t-butyltriethoxysilane, and the like.

The reaction product from the reaction (ii) has the general formula (I) wherein A is —O—, each R¹ is independently a straight chain alkyl group of from 1 to 4 carbon atoms or a branched chain alkyl group of from 3 to 4 carbon atoms; each R² is independently methyl or phenyl; each R³ is independently a straight chain alkylene group of from 1 to 6 carbon atoms or a branched chain alkylene group of from 3 to 6 carbon atoms; each R⁴ is independently hydrogen; R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is independently a straight chain alkylene group of from 2 to 6 carbon atoms, a branched chain alkylene group of from 3 to 6 carbon atoms or a group, each R⁷ is independently a straight chain alkylene group of from 2 to 6 carbon atoms or a branched chain alkylene group of from 3 to 6 carbon atoms, each R⁸ is

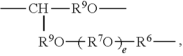

wherein each R⁹ is independently a straight chain alkylene group of from 1 to 5 carbon atoms or a branched chain alkylene group of from 3 to 5 carbon atoms; and the subscripts a, b, c, d, e and m are integers where each a is independently 0 or 1, b is 1, c is 2 or 3, each d is independently from 20 to 400, each e is independently from 0 to 100 and m is 0 or 1.

In yet another embodiment, the alkoxysilyl-containing polymers (a) can be obtained from the reaction (iii), which is the reaction of an isocyanatosilane with a polyol, which can be a single polyol or a mixture of from two or more polyols, and, advantageously, diols.

The reaction product from the reaction (iii) has the general formula (I) wherein A is —O—, each R¹ is independently a straight chain alkyl group of from 1 to 4 carbon atoms or a branched chain alkyl group of from 3 to 4 carbon atoms; each R² is independently methyl or phenyl; each R³ is independently a straight chain alkylene group of from 1 to 6 carbon atoms or a branched chain alkylene group of from 3 to 6 carbon atoms; each R⁴ is independently hydrogen; R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is independently a straight chain alkylene group of from 2 to 6 carbon atoms, a branched chain alkylene group of from 3 to 6 carbon atoms or a group, each R⁷ is independently a straight chain alkylene group of from 2 to 6 carbon atoms or a branched chain alkylene group of from 3 to 6 carbon atoms, each R⁸ is

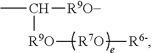

wherein each R⁹ is independently a straight chain alkylene group of from 1 to 5 carbon atoms or a branched chain alkylene group of from 3 to 5 carbon atoms; and the subscripts a, b, c, d, e and m are integers where each a is independently 0 or 1, b is 1, c is 2 or 3, each d is independently from 20 to 400, each e is independently from 0 to 100 and m is 0.

The synthesis according to reactions (i), (ii) or (iii) can be monitored using a standard titration technique for isocyanate content in the reaction mixture, according to ASTM D2572-19 Standard Test Method for Isocyanate Groups in Urethane Materials or Prepolymers, or infrared analysis. Silylation of the urethane prepolymers is considered complete when no residual —NCO can be detected by either technique.

In yet another embodiment, the alkoxysilyl-containing polymer (a) can be obtained from the reaction (iv), where an allyl-containing poly(oxyalkylene) polymer is reacted with a hydridoalkoxysilane.

The above-mentioned hydroxyl-functional polyols are converted into ethylenically unsaturated prepolymers in known manner by reaction with ethylenically unsaturated halo compounds. These prepolymers are prepared by reacting equivalent amounts of ethylenically unsaturated halo compounds with a polyol or a combination of polyols, usually in the presence of a strong base, such as alkali alkoxide, which deprotonates the hydroxyl group on the polyol.

Suitable polyether diols useful in the preparation were discussed above.

In an embodiment of the present invention, the polyols used in the production of the alkoxysilyl-containing polymer (a) are poly(oxypropylene) diols with number average molecular weights from about 1,000 grams/mole to about 20,000 grams/mole, more specifically about 2,000 grams/mole to about 18,000 grams/mole and even more specifically from about 8,000 grams/mole to about 12,000 grams/mole. Mixtures of polyols of various structures, molecular weights and/or functionalities can also be used. The number average molecular weights of the polyol are determined from the hydroxyl number and the functionality of the polyol. The hydroxyl number can be determined by ASTM D4274-05 Standard Test Methods for Testing Polyurethane Raw Materials: Determination of Hydroxyl Number of polyols. The unsaturation of the polyol can be determined by ASTM D4671-16 Standard Test Methods for Polyurethane Raw Materials: Determination of Unsaturation of Polyols.

In an embodiment, the polyether polyols can have a functionality up to about 3, in another embodiment a functionality of from about 1.8 to about 3 and in yet another embodiment a functionality of about 1.95 to about 2.05 (i.e., diols). Especially suitable are the polyether polyols prepared in the presence of double-metal cyanide (DMC) catalysts, an alkaline metal hydroxide catalyst, or an alkaline metal alkoxide catalyst, such as those which are known by those skilled in the art. Polyether polyols produced in the presence of such catalysts tend to have high molecular weights and low levels of unsaturation, properties of which, it is believed, are responsible for the improved performance of inventive retroreflective articles. The polyether polyols preferably have a number average molecular weight of from about 1,000 to about 25,000, more preferably from about 2,000 to about 20,000, and even more preferably from about 4,000 to about 18,000. The polyether polyols preferably have an end group unsaturation level of no greater than about 0.04 milliequivalents per gram of polyol. More preferably, the polyether polyol has an end group unsaturation of no greater than about 0.02 milliequivalents per gram of polyol. Examples of commercially available diols that are suitable for making the isocyanate-terminate PUR prepolymer include ARCOL R-1819 (number average molecular weight of 8,000), E-2204 (number average molecular weight of 4,000), and ARCOL E-2211 (number average molecular weight of 11,000).

The ethylenically unsaturated polymers useful in the preparation of the alkoxysilyl-containing polymers (a) are provided by general formula (XIV):

CH₂═CRCH₂—O(R⁷O)_{d}(R⁸O)_{c-2}—CH₂CR═CH₂ (XIV)

wherein

each R is independently hydrogen or methyl,

each R⁷ is independently a straight chain alkylene group of from 2 to 6 carbon atoms or a branched chain alkylene group of from 3 to 6 carbon atoms,

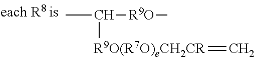

wherein each R⁹ is independently a straight chain alkylene group of from 1 to 5 carbon atoms or a branched chain alkylene group of from 3 to 5 carbon atoms; and

the subscripts c, d and e are integers where, c is 2 or 3, each d is independently from 20 to 400, and each e is independently from 0 to 100.

The reaction conditions for the preparation of the ethylenically unsaturated polymers are well known in the art, as for example described in U.S. Pat. Nos. 3,951,888 and 3,971,751, the entire content of which are incorporated herein by reference. The reaction to form these ethyleneically unsaturated polymer involve the deprotonation of the hydroxyl groups using alkali hydroxides or alkoxides, followed by the reaction with an ethylenically unsaturated halogen compound.

Representative non-limiting examples of ethylenically unsaturated halogen compounds, include allyl chloride, methallyl chloride, allyl bromide or allyl iodide.

The ethylenically unsaturated prepolymer is hydrosilated with hydrolysable hydridosilane having the formula (XV):

H—Si(R²)ₐ(OR¹)₃₋ₐ (XV)

wherein R¹ is independently a straight chain alkyl group of from 1 to 4 carbon atoms or a branched chain alkyl group of from 3 to 4 carbon atoms; R² is methyl or phenyl, and a is an integer, where a is 0 or 1.

The conditions for hydrosilation of intermediates containing carbon-carbon double bonds is well known in the art, such as described in “Comprehensive Handbook of Hydrosilylation,” B. Marciniec (ed), Pergamon Press, New York (1992), which is included in its entirety herein by reference.

Useful hydrolysable hydridosilanes include, but are not limited to, H—Si(OCH₃)₃, H—Si(OCH₂CH₃)₃, H—SiCH₃(OCH₃)₂, H—SiCH₃(OCH₂CH₃)₂, and the like.

The reaction product from the reaction (iv) has the general formula (I) wherein A is —O— each R¹ is independently a straight chain alkyl group of from 1 to 4 carbon atoms or a branched chain alkyl group of from 3 to 4 carbon atoms; each R² is independently methyl or phenyl; each R³ is independently a straight chain alkylene group of from 1 to 6 carbon atoms or a branched chain alkylene group of from 3 to 6 carbon atoms; each R⁴ is independently hydrogen; R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is independently a straight chain alkylene group of from 2 to 6 carbon atoms, a branched chain alkylene group of from 3 to 6 carbon atoms or a group, each R⁷ is independently a straight chain alkylene group of from 2 to 6 carbon atoms or a branched chain alkylene group of from 3 to 6 carbon atoms, each R⁸ is

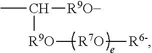

wherein each R⁹ is independently a straight chain alkylene group of from 1 to 5 carbon atoms or a branched chain alkylene group of from 3 to 5 carbon atoms; and the subscripts a, b, c, d, e and m are integers where each a is independently 0 or 1, b is 0, c is 2 or 3, each d is independently from 20 to 400, each e is independently from 0 to 100 and m is 0.

In one embodiment, the terms and subscripts of the moisture-curable silylated polymer of formula (I) can be A is —O—, R¹ is methyl, R² is methyl, R³ is —CH₂CH₂CH₂—, R⁴ is hydrogen, R⁵ is —R⁶O(R⁷O)_{d}[C(═O)NH—R⁰—NHC(═O)O(R⁷O)_{d}]ₘR⁶—, wherein each R⁶ and R⁷ is an alkylene group of from 2 to 6 carbon atoms, including —CH(CH₃)CH₂— and/or —CH₂CH(CH₃)—, R⁰ is hexylene or

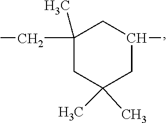

and m is 0 or 1, a is 0 or 1, more specifically 0, b is 1, c is 2 and d is 100 to 350.

In another embodiment, the terms and subscripts of the moisture-curable silylated polymer of formula (I) can be A is —NR⁴—, where R⁴ is hydrogen, a straight chain alkylene of from 1 to 3 carbon atoms, R¹ is methyl, R² is methyl, R³ is —CH₂CH₂CH₂—, —CH₂CH(CH₃)CH₂— or —CH₂C(CH₃)₂CH₂CH₂—, R⁵ is —R⁶O(R⁷O)_{d}[C(═O)NH—R⁰—NHC(═O)O(R⁷O)_{d}]ₘR⁶—, wherein each R⁶—C(═O)NH—R⁰—NHC(═O)—, where R⁰ is hexylene or

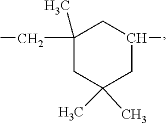

R⁷ is an alkylene group of from 2 to 6 carbon atoms, including —CH(CH₃)CH₂— and/or —CH₂CH(CH₃)—, and m is 0 or 1, a is 0 or 1, more specifically 0, b is 0, c is 2 and d is 100 to 350.

The amount of alkoxysilyl-containing polymer (a) in the moisture-curable silylated polymer composition is set to 100 parts by weight.

The UV light stabilizer package comprises
(i) at least one light stabilizer of formula (III) or formula (V);
(ii) at least one sterically hindered amine compound of formula (VI) or formula (VII); and
(iii) at least one silicon compound containing a conjugated C═C group and having the structure of formula (VIII).

The light stabilizer (b)(i) of formula (III) can be a benzotriazole or a benzotriazole derivative, preferably a 2-(2′-hydroxyphenyl)benzotriazole derivative.

Representative and non-limiting examples of light stabilizers (b)(i) of formula (III) include poly(oxy-1,2-ethanediyl), α-(3-(3-(2H-benzotriazol-2-yl)-5-(1,1-dimethylethyl)-4-hydroxyphenyl)-1-oxopropyl)-w-hydroxy; poly(oxy-1,2-ethanediyl), a-(3-(3-(2H-benzotriazol-2-yl)-5-(1,1-dimethylethyl)-4-hydroxyphenyl)-1-oxopropyl-w-(3-(3-(2H-benzotriazol-2-yl-5-(1,1-dimethylethyl)-4-hydroxyphenyl)-1-oxopropoxy); a-3-(3-(2H-benzotriazol-2-yl)-5-tert-butyl-4-hydroxyphenyl)propionyl-w-hydroxypoly(oxyethylene); α-3-(3-(2H-benzotriazol-2-yl)-5-tert-butyl-4-hydroxyphenyl)propionyl-ω-3-(3-(2H-benzotriazol-2-yl)-5-tert-butyl-4-hydroxyphenyl)propionyloxypoly(oxyethylene); 2-(2′-hydroxy-5′-methylphenyl)-benzotriazole; 2-(3′,5′-di-tert-butyl-2′-hydroxyphenyl)-benzotriazole; 2-(5′-tert-butyl-2′-hydroxyphenyl)-benzotriazole; 2-(2′-hydroxy-5′-(1,1,3,3-tetramethylbutyl)-phenyl)-benzotriazole; 2-(3′,5′-di-tert-butyl-2′-hydroxyphenyl)-5-chlorobenzotriazole; 2-(3′-tert-butyl-2′-hydroxy-5′-methylphenyl)-5-chlorobenzotriazole; 2-(3′-sec-butyl-5′-tert-butyl-2′-hydroxyphenyl)-benzotriazole; 2-(2′-hydroxy-4′-octyloxyphenyl)-benzotriazole; 2-(3′,5′-di-tert-amyl-2′-hydroxyphenyl)-benzotriazole; 2-(3′,5′-bis(α,α-dimethylbenzyl)-2′-hydroxyphenyl)-benzotriazole; 2-(3′-tert-butyl-2′-hydroxy-5′-(2-octyloxycarbonylethyl)phenyl)-5-chlorobenzotriazole; 2-(3′-tert-butyl-5′-[2-(2-ethylhexyloxy)carbonylethyl]-2′-hydroxyphenyl)-5-chlorobenzotriazole; 2-(3′-tert-butyl-2′-hydroxy-5′-(2-methoxycarbonylethyl)phenyl)-5-chlorobenzotriazole; 2-(3′-tert-butyl-2′-hydroxy-5′-(2-methoxycarbonylethyl)phenyl)-benzotriazole; 2-(3′-tert-butyl-2′-hydroxy-5′-(2-octyloxycarbonylethyl)phenyl)-benzo-triazole; 2-(3′-tert-butyl-5′-[2-(2-ethylhexyloxy)carbonylethyl]-2′-hydroxyphenylybenzotriazole; 2-(3′-dodecyl-2′-hydroxy-5′-methylphenyl)-benzotriazole; 2-(3′-tert-butyl-2′-hydroxy-5′-(2-isooctyloxycarbonylethyl)-phenyl-benzotriazole; 2,2′-methylenebis[4-(1,1,3,3-tetramethylbutyl)-6-benzotriazol-2-yl-phenol]; and, combinations thereof.

Representative and non-limiting examples of light stabilizer (b)(i) mixtures include poly(oxy-1,2-ethanediyl), a-(3-(3-(2H-benzotriazol-2-yl)-5-(1,1-dimethylethyl)-4-hydroxyphenyl)-1-oxopropyl)-w-hydroxy and poly(oxy-1,2-ethanediyl), α-(3-(3-(2H-benzotriazol-2-yl)-5-(1,1-dimethylethyl)-4-hydroxyphenyl)-1-oxopropyl-ω-(3-(3-(2H-benzotriazol-2-yl-5-(1,1-dimethylethyl)-4-hydroxyphenyl)-1-oxopropoxy); and α-3-(3-(2H-benzotriazol-2-yl)-5-tert-butyl-4-hydroxyphenyl)propionyl-w-hydroxypoly(oxyethylene); α-3-(3-(2H-benzotriazol-2-yl)-5-tert-butyl hydroxyphenyl)propionyl-ω-3-(3-(2H-benzotriazol-2-yl)-5-tert-butyl hydroxyphenyl)propionyloxypoly(oxyethylene) and poly(oxy-1,2-ethanediyl), α-hydro-ω-hydroxy-ethane-1,2-diol, ethoxylated.

The light stabilizer (b)(i) of formula (III) are commercially available and can be obtained from companies such as Everlight Chemical and BASF and include under the trade names Tinuvin® 213, a mixture of poly(oxy-1,2-ethanediyl), α-(3-(3-(2H-benzotriazol-2-yl)-5-(1,1-dimethylethyl)-4-hydroxyphenyl)-1-oxopropyl)-w-hydroxy (CAS #104810-48-2) and poly(oxy-1,2-ethanediyl), α-(3-(3-(2H-benzotriazol-2-yl)-5-(1,1-dimethylethyl)-4-hydroxyphenyl)-1-oxopropyl-ω-(3-(3-(2H-benzotriazol-2-yl-5-(1,1-dimethylethyl)-4-hydroxyphenyl)-1-oxopropoxy) (CAS #104810-48-1), available from BASF; Tinuvin® 384-1, a mixture of 95% benzenepropanoic acid, 3-(2H-benzotriazol-2-yl)-5-(1,1-dimethylethyl)-4-hydroxy-C7-9-branched and straight chain alkyl esters (CAS #127519-17-9); and 5% 1-methoxy-2-propyl acetate (CAS #108-65-6), available from BASF; and Eversorb® 80, a mixture of a-[3-[3-(2H-benzotriazol-2-yl)-5-(1,1-dimethylethyl)-4-hydroxyphenyl]-1-oxopropyl]-w-hydroxypoly(oxo-1,2-ethanediyl) (CAS #104810-48-2); a-[3-[3-(2H-benzotriazol-2-yl)-5-(1,dimethylethyl)-4-hydroxyphenyl]-1-oxopropyl]-w-[3-[3-(2H-benzotriazol-2-yl)-5-(1,1-dimethylethyl)-4-hydroxyphenyl]-1-oxopropoxy]poly(oxy-1,2-ethanediyl) (CAS #104810-48-2) and PEG300, (CAS #25322-68-3, available from Everlight Chemical.

The light stabilizer (b)(i) can be oxaldianilidines of general formula (IV). These compounds are commercially available.

Representative and non-limiting examples include a N-(2-ethoxyphenyl)-N′-(2-ethylphenyl)ethylenediamide (CAS: 23949-66-8), N,N′-diphenylethylenediamide (CAS: 620-81-5), N-(5-(1,1-dimethylethyl)-2-ethoxyphenyl)-N′-(2-ethylphenyl)ethylenediamide (CAS: 35001-52-6) and N-(2-ethoxyphenyl)-N′-(4-isododecylphenyl)ethylenediamide (CAS: 82493-14-9), more particularly N-(2-ethoxyphenyl)-N′-(2-ethylphenyl)ethylenediamide (CAS: 23949-66-8) and N-(2-ethoxyphenyl)-N′-(4-isododecylphenyl)ethylenediamide (CAS: 82493-14-9).

The oxadianilidine of general formula (IV) can be solid which makes them more difficult to incorporate into the moisture-curable silylated polymer composition.

The 2-(2′-hydroxyphenyl)benzotriazole derivatives, which are liquids, are particularly useful in the invention.

The amount of the light stabilizer (b)(i) may be included from about 0.5 to about 3 parts by weight per 100 parts by weight of the alkoxysilyl-containing polymer (a) and more preferably from about 0.8 to about 2 parts by weight per 100 parts by weight of the alkoxysilyl-containing polymer (a).

A sterically hindered amine compounds (b)(ii) having formula (VI) or formula (VII) can be used in the moisture-curable silylated polymer composition as part of the stabilizer package.

Representative, non-limiting examples of the sterically hindered amine compounds (b)(ii) include 3-(2,2,6,6-tetramethyl-piperidin-4-yloxy)-propionic acid, 4-(2,2,6,6-tetramethyl-piperidin-4-yl)-butyric acid, poly-[4-(2,2,6,6-tetramethyl-piperidin-4-yl)-butyric acid] ester, poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]], bis(2,2,6,6-tetramethyl-4-piperidyl)maleate, bis(2,2,6,6-tetraethyl-4-piperidyl)maleate, bis(2,2,6,6-tetramethyl-4-piperidyl)maleate, bis(2,2,6,6-tetrahexyl-4-piperidyl)sebacate, bis(1,2,2,6,6-pentamethyl-4-piperidinyl)-2-butyl-2-(4-hydroxy-3,5-di-tert-butylbenzyl)propanedioate, poly-[7-(4-hydroxy-2,2,6,6-tetramethyl-piperidin-1-yl)-4-oxo-heptanoic acid] ester, poly-[6-(4-hydroxy-2,2,6,6-tetraethyl-piperidin-1-yl)-hexanoic acid] ester, poly-[7-(4-hydroxy-2,2,6,6-tetramethyl-piperidin-1-yl)-4-oxo-heptanoic acid] ester, 7-(4-hydroxy-2,2,6,6-tetramethyl-piperidin-1-yl)-4-oxo-heptanoic acid 1-tert-butyl-2,2,6,6-tetramethyl-piperidin-4-yl ester, 7-(4-hydroxy-2,2,6,6-tetramethyl-piperidin-1-yl)-4-oxo-heptanoic acid, 8-(4-hydroxy-2,2,6,6-tetramethyl-piperidin-1-yl)-5-oxo-octanoic acid, 6-(4-hydroxy-2,2,6,6-tetramethyl-piperidin-1-yl)-hexanoic acid, 4-(4-hydroxy-2,2,6,6-tetramethyl-piperidin-1-yl)-benzoic acid, polymer resulting from the reaction of dimethylbutanedioate with 4-hydroxy-2,2,6,6-tetramethyl-1-piperidine ethanol, and mixtures thereof.

These sterically hindered amine compounds (b)(ii) are commercially available and include, as nonlimiting examples, Tinuvin® 292, a mixture of bis-(N-methyl,2,2,6,6-tetramethyl-4-piperidinyl) sebacate (CAS #41556-26-7) and methyl-(N-methyl,2,2,6,6-tetramethyl-4-piperidinyl) sebacate (CAS #82919-37-7) available from BASF; Tinuvin® 770, bis(2,2,6,6,-tetramethyl-4-piperidyl)sebacate, available from BASF; Eversorb 93, a mixture of bis-(N-methyl-2,2,6,6-tetramethyl-4-piperidinyl) sebacate (CAS #41556-26-7) and methyl-(N-methyl-2,2,6,6-tetramethyl-4-piperidinyl) sebacate (CAS #82919-37-7) available from Everlight Chemical; and Tinuvin® 765, a mixture of bis(1,2,2,6,6-pentamethyl-4-piperidyl)sebacate and methyl 1,2,2,6,6-pentamethyl-4-piperidyl sebacate, available from Ciba-Geigy.

The amount of the sterically hindered amine compounds (b)(ii) may be included from about 0.2 to about 1.5 part by weight per 100 parts by weight of the alkoxysilyl-containing polymer (a), and more preferably from about 0.4 to about 0.8 part by weight per 100 parts by weight of the alkoxysilyl-containing polymer (a).

The silicon compound containing a conjugated C═C group (b)(iii) has the general formula (VIII). These silicon compounds containing a conjugated C═C group (b)(iii) provide for a reduction in yellowing when exposed to ultra-violet light and air.

Representative and non-limiting examples of these compounds include phenyltrimethoxysilane, phenylmethyldimethoxysilane, phenyltriethoxysilane, phenylmethyldiethoxysilane, diphenylmethylmethoxysilane, diphenylmethylethoxysilane, 3-methacryloxypropyltrimethoxysilane, 3-methacryloxypropyltriethoxysilane or 3-methacryloxypropylmethyldimethoxysilane.

The silicon compound containing a conjugated C═C group (b)(iii) are commercially available, such as phenyltrimethoxysilane, available from Gelest, Inc. under the tradename SIP6822.0 and 3-methacryloxypropyltrimethoxysilane, available from Momentive Performance Materials, Inc. under the tradename Silquest® A-174 silane.

The amount of silicon compound containing a conjugated C═C group (b)(iii) useful in the present invention ranges from about 0.5 to about 5.0 parts by weight per 100 parts by weight of the alkoxysilyl-containing polymer (a) and more particularly from about 1.0 to about 2.5 parts by weight per 100 parts by weight of the alkoxysilyl-containing polymer (a).

The adhesion promoter containing an alkoxysilyl group (c) is added to the moisture-curable silylated polymer composition to improve adhesion to various substrates, especially metals, glass, ceramics and stone.

In one embodiment, the adhesion promoter containing an alkoxysilyl group (c) has the general formula (XVI):

A³[R³⁶—Si(CH₃)ₙ(OR³⁷)₃₋ₙ]ₒ (XVI)

wherein

A³ is a monovalent functional group selected from H₂N—, H₂NCH₂CH₂NH—, CH₃NH—, CH₃CH₂NH—, CH₃(CH₂)₂NH—, CH₃(CH₂)₃NH— and glycidoxy-, a divalent functional group —NH—, or a trivalent functional group, isocyanaurato-;

each R³⁶ is independently a straight chain alkylene group of from 1 to 6 carbon atoms or a branched chain alkylene group of from 3 to 6 carbon atoms;

each R³⁷ is independently a straight chain alkyl group of from 1 to 4 carbon atoms or a branched chain alkyl group of from 3 to 4 carbon atoms; and

the subscripts n and o are integers where n is 0 or 1 and o is 1, 2 or 3, with the provisos that when monovalent, o is 1, when A³ is divalent, o is 2 and when A³ is trivalent, o is 3.

Representative and non-limiting examples of adhesion promoters (c) include 3-aminopropyltrimethoxysilane, available from Momentive Performance Materials, Inc. under the tradename Silquest* A-1110 silane, 3-aminopropyltriethoxysilane, available from Momentive Performance Materials, Inc. under the tradename Silquest* A-1100 silane, N-(2-aminoethyl)-3-aminopropyltrimethoxysilane, available from Momentive Performance Materials, Inc. under the tradename Silquest* A-1120 silane, N-ethyl 3-amino-2-methylpropyltrimethoxysilane, available from Momentive Performance Materials, Inc under the tradename A-Link* A-15 silane, bis-(trimethoxysilylpropyl) amine, from Momentive Performance Materials, Inc. under the tradename Silquest* A-1170 silane, N, N′, N″-tris-(3-trimethoxysilylpropyl)isocyanurate, available from Momentive Performance Materials, Inc. under the tradename A-Link* 597 silane, N-(2-ethyl)3-aminopropylmethyldimethoxysilane, available from Momentive Performance Materials, Inc. under the tradename Silquest* A-2120 silane, 3-glycidoxypropyltrimethoxysilane, available Momentive Performance Materials, Inc. under the tradename Silquest* A-187 silane, 3-glycidoxypropyltriethoxysilane, available Momentive Performance Materials, Inc. under the tradename Silquest* A-1871 silane, and 3-glycidoxypropylmethyldiethoxysilane, available Momentive Performance Materials, Inc. under the tradename CoatOSil* 2287 silane.

The amount of the adhesion promoter containing an alkoxysilyl group (c) may be included from about 0.5 to about 5 parts by weight per 100 parts by weight of the alkoxysilyl-containing polymer (a), and more preferably from about 1.5 to about 3 parts by weight per 100 parts by weight of the alkoxysilyl-containing polymer (a).

A curing catalyst (d) is used to promote the curing of the curing of the moisture-curable silylated polymer composition.

The curing catalyst (d) of the moisture-curable silylated polymer composition can be any catalyst that is effective in promoting the reaction between alkoxysilyl-containing polymer (a) when exposed to moisture. Suitable cure catalysts include but not limited to organometallic catalysts, amine catalysts, and the like. Preferably, the catalyst is selected from the group consisting of organic dibutyltin, zirconium complex, aluminum chelate, titanic chelate, organic zinc, organic cobalt, organic iron, organic nickel and organobismuth, and mixtures thereof. Amine catalysts are selected from the group consisting of primary amine, secondary amine, tertiary amine and aminosilane and mixtures thereof. The catalyst can be a mixture of organometallic catalyst and amine catalyst.

Representative and non-limiting examples of catalysts include, but are not limited to, dibutyltin oxide, dibutyltin dilaurate, dioctyltin dilaurate, dibutyltin diacetate, stannous octoate, stannous acetate, stannous oxide, morpholine, 3-aminopropyltrimethoxysilane, 2-(aminoethyl)-3-aminopropyltrimethoxysilane, tri-isopropylamine, bis-(2-dimethylaminoethyl) ether, 1,8-diazabicyclo[5.4.0]undec-7-ene and piperazine.

Particularly useful catalysts include titanium compounds such as tetra-tert-butyl orthotitanate, titanium(IV) bis(ethylacetoacetato)diisobutoxide, titanium(IV) bis(ethylacetoacetato)dimethoxide, titanium(IV) bis(ethylacetoacetato)diethoxide, titanium(IV) bis(ethylacetoacetato)monoethoxide monomethoxide or titanium(IV) bis(ethylacetoacetato)diisopropoxide; organic tin compounds such as di-n-butyltin dilaurate, di-n-butyltin diacetate, di-n-butyltin oxide, di-n-butyltin dineodecanoate, di-n-butyltin diacetylacetonate, di-n-butyltin maleate, di-n-octyltin diacetate, di-n-octyltin dilaurate, di-n-octyltin oxide, di-n-octyltin maleate, di-n-octyltin di(2-ethyl)hexanoate, di-n-octyltin neodecanoate, di-n-octyltin isodecanoate, or the partial hydrolysis products thereof of organic tin compounds or titanium compounds, or the reaction products of these organic tin compounds or titanium compounds or partial hydrolysis products of organic tin compounds or titanium compounds with alkoxysilanes such as tetraethoxysilane, methyltriethoxysilane, methyltrimethoxysilane, propyltrimethoxysilane, 3-aminopropyltrimethoxysilane, 3-aminopropyltriethoxysilane, 2-aminoethyl-3-aminopropyltrimethoxysilane, 2-aminoethyl-3-aminopropyltrimethoxysilane; or mixtures or reaction products of titanium or organic tin compounds with phosphonic acids, phosphinic acids, phosphonic acid monoesters or phosphoric acid mono or diesters.

Other useful catalysts include zirconium-contain, aluminum-containing and bismuth-contain complexes such as KAT XC6212, K-KAT 5218 and K-KAT 348, supplied by King Industries, Inc., titanium chelates such as the TYZOR® types, available from DuPont, the KR types, available from Kenrich Petrochemical, Inc., amines such as NIAX A-501 amine, available from Momentive Performance Materials, Inc., and the like.

The amount of catalyst (d) used in the moisture-curable silylated polymer composition can be in the range from about 0.1 to about 3 parts by weight per 100 parts by weight of the alkoxysilyl-containing polymer (a), and more particularly, from about 0.3 to about 1 parts by weight per 100 parts by weight of the alkoxysilyl-containing polymer (a).

Other Components

The moisture-curable composition can further comprise other components including antioxidant stabilizer additives, plasticizers, solvents, rheology modifiers and the like.

Anti-oxidants can be used to stabilize the alkoxysilyl-containing polymer (a). A variety of phenols and piperidinyloxy free radicals are suitable for stabilizing the alkoxysilyl-containing polymer (a).

Representative non-limiting examples of phenols suitable for stabilizing the composition include tetrakis[methylene(3,5-di-tert-butyl-4-hydroxyhydrocinnamate)]methane; octadecyl 3,5-di-tert-butyl hydroxyhydrocinnamate; 3,5-di-tert-butyl-4-hydroxyhydrocinnamic acid, C7-9 branched alkyl esters; 1,3,5-trimethyl-2,4,6-tris(3,5-di-tert-butyl-4-hydroxybenzyl)benzene; 2,6-di-tert-butyl-4-(N,N′-dimethylaminomethyl)phenol; and 2,6-di-tert-butyl-4-methylphenol.

Representative non-limiting examples of piperidinyloxy free radicals include 2,2,6,6-tetramethyl-1-piperidinyloxy free radical; and 4-hydroxy-2,2,6,6-tetramethyl-1-piperidinyloxy free radical (4-hydroxy TEMPO). Vitamin E maybe also be used as an antioxidant for stabilization of the alkoxysilyl-containing polymer (a).

The phenolic anti-oxidant additives can be used either alone or in combination. These phenolic additives can be used at a level of about 0.01 to 0.2 parts by weight per weight per 100 parts by weight of the alkoxysilyl-containing polymer (a). The piperidinyloxy free radicals can be used at a level of about 0.0001 to 0.02 parts by weight per 100 parts by weight of the alkoxysilyl-containing polymer (a), and more specifically about 0.001 to 0.002 parts by weight per 100 parts by weight of the alkoxysilyl-containing polymer (a).

Plasticizers can be used in the compositions to lower the viscosity of the uncured moisture-curable compositions and to adjust the cured properties of these compositions, such as modulus. Examples of plasticizers are high-boiling hydrocarbons, for example, liquid paraffins, dialkylbenzenes, dialkylnaphthalenes or mineral oils consisting of naphthenic and paraffinic units, polyglycols, in particular polyoxypropylene glycols, which can optionally be substituted, high-boiling esters such as phthalates, citric acid esters or diesters of dicarboxylic acids, liquid polyesters, polyacrylates or polymethacrylates and alkanesulfonic acid esters.

If the moisture-curable compositions contain plasticizers, the amounts are preferably from about 1 to about 100 parts by weight, more preferably from about 10 to about 85 parts by weight, and in particular from about 20 to about 75 parts by weight, based on 100 parts by weight of the alkoxysilyl-containing polymer (a). The compositions preferably contain plasticizers.

The moisture-curable composition can optionally comprise rheology modifier additives. These rheology modifiers additives modify the rheology of the composition. Representative and non-limiting examples of rheology modifiers useful in the present invention include, for example, surface treated fumed silica having a mean particle size of less and 12 nanometers, and preferably, less than 7 nanometers, as measured in accordance with ASTM 958-92 (2014) Standard Test Methods for Particle Size Distribution of Alumina and Quartz by X-ray Monitoring of Gravity Sedimentation. Surface-treated fumed silica may be obtained as from Evonik, under the tradenames Aerosil® R 974, R 9200, R 8200, R 805, R 104, R812 and 812S, and R-106 or from Cabot under the tradename CAB-O-SIL® ULTRABOND.

The of such rheology modifier additives can be included in the range from about 1 to about 40 parts by weight and more preferably from about 4 to about 15 parts, by weight based on 100 parts by weight of the alkoxysilyl-containing polymer (a).

All conventional organic solvents can be used optionally as organic solvents. The organic solvents suitable for use have a water content of less than about 5 weight percent, by weight, in particular of less than about 1 percent by weight, and more particularly less than about 0.00001 percent by weight percent, based on the weight of the organic solvent. Non-liming and representative example include, for example, alcohols such as methanol, ethanol, isopropanol or 1,2-propanediol; ketones such as acetone or cyclohexanone; methyl ethyl ketoxime; esters such as butyl acetate, ethyl oleate, butoxyethoxyethyl acetate; diethyl adipate, propylene carbonate, glyceryl triacetate or dimethyl phthalate; ethers such as dipropylene glycol monomethyl ether, tetrahydrofuran or butoxyethoxyethanol; amides such as N,N-dimethylacetamide or N,N-dimethylformamide; pyrrolidones such as N-methyl-2 pyrrolidone or N-octyl-2-pyrrolidone; hydrocarbons such as hexane, cyclohexane, octane, dodecane or mineral spirits; halogenated hydrocarbons such as trichloroethane or difluorotetrachloroethane; and aromatics such as alkylnaphthenes or alkylbenzenes.

If the compositions contain organic solvents, the amounts are from about 0.1 to about 70 parts by weight, preferably from about 0.2 to about 10 parts by weight, and more preferably from about 0.5 to about 2 parts by weight, based in each case on 100 parts by weight of the alkoxysilyl-containing polymer (a).

The moisture-curable silylated polymer composition is non-yellowing, as characterized by a percent change in b* value, as measured by a colorimeter of from −30% to about 5%, preferably from about −20% to about 0%, and most preferably from about −15% to about 0% following a period of UV exposure under ISO 4892-2:2013 Annex B, Method B, cycle B7 of 7 days, where the percent change in b* value is determined by measuring the b* value using a colorimeter of the composition after curing and after exposure to UV light, denoted b*(UV), and measuring the b* value of after curing of the composition and before exposure to UV light, denoted b*(initial), and then using the equation:

Percent non-yellowing value=100%×[(b*(UV)−b*(initial))/b*(initial)].

In one embodiment, a silylated polymer composition is provided comprising:

(a) 100 parts by weight of an alkoxysilyl-containing polymer having the general formula (I):

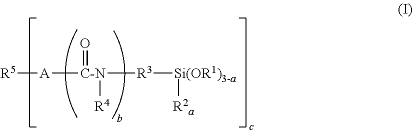

wherein

each A is independently —O— or —N(R⁴) or more specifically —O—;

each R¹ is methyl or ethyl or more specifically methyl;

each R² is methyl;

each R³ is methylene, propylene, 2-methylpropylene, 2,2-dimethylbutylene, or more specifically propylene;

each R⁴ is methyl, ethyl, phenyl or hydrogen, or more specifically methyl or ethyl;
R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶—(II)

wherein each R⁶ is independently ethylene, 2-methylethylene, 1-methylethylene or —C(═O)NH—R⁰—NHC(═O)— group, where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms or more specifically, hexylene or

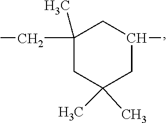

each R⁷ is independently ethylene, 2-methylethylene or 1-methylethylene, each R⁸ is

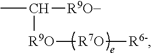

wherein each R⁹ is independently methylene, ethylene, propylene or more specifically methylene; and the subscripts a, b, c, d, e and m are integers where each a is independently 0 or 1, more specifically 0, b is 0 or 1, or more specifically 1, c is 2 or 3, or more specifically 2, d is from 20 to 400, each e is independently from 0 to 100 and m is 0 or 1, more specifically 1, with the provisos that if R⁶ is —C(═O)NH—R⁰—NHC(═O)— group, then A is —N(R⁴)— and b is 0;

(b) a UV light stabilizer package comprising:
(i) about 0.5 to about 3 parts by weight per 100 parts by weight of the alkoxysilyl-containing polymer (a) of at least one light stabilizer having the formula (III):

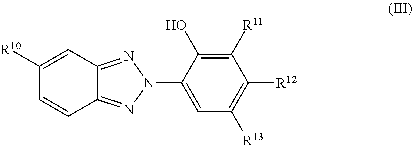

wherein

R¹⁰ is hydrogen or chloro;

R¹¹ is hydrogen, a straight chain alkyl group of from 1 to 12 carbon atoms, a branched chain alkyl group of from 3 to 12 carbon atoms, a

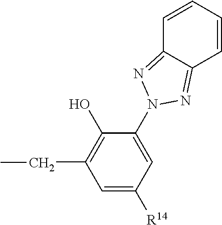

group, where R¹⁴ is a straight chain alkyl group of from 1 to 12 carbon atom or a branched chain alkyl group of from 3 to 12 carbon atoms, or an —OR¹⁵ group, where R¹⁵ is a straight chain alkyl group of from 1 to 12 carbon atoms or a branched chain alkyl group of from 3 to 12 carbon atoms;

R¹² is hydrogen, a straight chain alkyl group of from 1 to 12 carbon atoms, a branched chain alkyl group of from 3 to 12 carbon atoms or an —OR¹⁶ group, where R¹⁶ is a straight chain alkyl group of from 1 to 12 carbon atoms or a branched chain alkyl group of from 3 to 12 carbon atoms;

R¹³ is hydrogen, a straight chain alkyl group of from 1 to 12 carbon atoms, a branched chain alkyl group of from 3 to 12 carbon atoms, an —OR³⁹ group, where R³⁹ is a straight chain alkyl group of from 1 to 12 carbon atoms or a branched chain alkyl group of from 3 to 12 carbon atoms, or a —(CH₂)_{f}C(═O)O(C_{g}H_{2g}O)ₕR¹⁷, where R¹⁷ is hydrogen, a straight chain alkyl group of from 1 to 12 carbon atoms, a branched chain alkyl group of from 3 to 12 carbon atoms or a group of formula (IV):

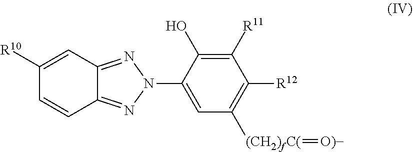

with the proviso that when R¹⁷ is the group of formula (IV), then h is 1 to 15; and

the subscripts f, g and h are integers where f is from 0 to 6, g is from 2 to 4 and h is from 0 to 15;
(ii) about 0.2 to about 1.5 parts by weight per 100 parts by weight of the alkoxysilyl-containing polymer (a) of at least one sterically hindered amine compound having the formula (VI):

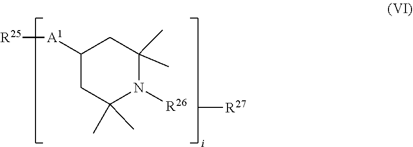

wherein

each A¹ is independently selected from the group consisting of straight chain alkenylene groups of from 1 to 10 carbon atoms, branched chain alkylene groups of from 3 to 10 carbon atoms or a chemical single bond;

each R²⁵ and R²⁷ is independently hydrogen, a straight chain alkyl group of 1 to 10 carbon atoms, a branched chain alkyl group of from 3 to 10 carbon atoms, a hydroxyl group, an amino group, —NR³⁸2, where R³⁸ is independently hydrogen, a straight chain alkyl group of from 1 to 6 carbon atoms or a branched chain alkyl group of from 3 to 6 carbon atoms;

each R²⁶ is independently a straight chain alkylene group of from 1 to 10 carbon atoms, a branched chain alkylene group of from 3 to 10 carbon atoms, arylene group of from 6 to 10 carbon atoms, aralkylene group of 7 to 10 carbon atoms or a divalent organic group of 1 to 20 carbon atoms containing at least one divalent oxygen atoms forming an ether group, a —C(═O)O— group forming an ester functional group, carbonyl group, a primary amido group, a secondary amido group, a primary amino group, a secondary amino group or tertiary amino group; and

the subscript i is an integer from 1 to 100; or sterically hindered amine compound having the formula (VII):

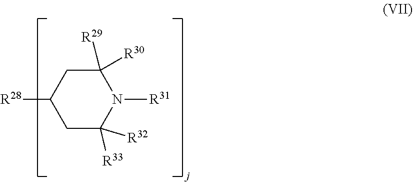

wherein

R²⁸ is hydrogen, a monovalent or polyvalent hydrocarbon group containing from 1 to 16 carbon atoms, a monovalent or polyvalent organic group of from 1 to 24 carbon atoms containing at least one triazinyl group, pyrimidinyl group, pyridinyl group, 2,4,6-trione-1,3,5-triazinyl group, divalent oxygen atoms forming an ether group, a —C(═O)O— group forming an ester functional group, carbonyl group, a primary amido group or secondary amido group, a primary amino group, a secondary amino group or tertiary amino group;

each R²⁹, R³⁰, R³² and R³³ is independently a straight chain alkyl group of from 1 to 6 carbon atoms or a branched chain alkyl group of from 3 to 6 carbon atoms;

each R³¹ is independently hydrogen, a straight chain alkyl group of from 1 to 10 carbon atoms, a branched chain alkyl group of from 3 to 10 carbon atoms, an aryl group of from 6 to 10 carbon atom or an aralkyl of from 7 to 10 carbon atoms; and

the subscript j is an integer from 1 to 5.
(iii) about 0.5 to about 5 parts by weight per 100 parts by weight of the alkoxysilyl-containing polymer (a) of a silicon compound containing a conjugated C═C group having the general formula (VIII):

A²Si(CH₃)ₖ(OR³⁵)₃₋ₖ (VIII)

wherein

A² is CH₂═C(CH₃)C(═O)OCH₂CH₂CH₂—;

R³⁵ is methyl or ethyl or more specifically methyl; and

k is an integer 0 or 1 or more specifically 0;

(c) 0.5 to 5 parts by weight per 100 parts by weight of the alkoxysilyl-containing polymer (a) of an adhesion promoter containing an alkoxysilyl group having the general formula (XVI):

A³[R³⁶—Si(CH₃)ₙ(OR³⁷)₃₋ₙ]ₒ (XVI)

wherein

A³ is a monovalent functional group selected from H₂N—, H₂NCH₂CH₂NH—, CH₃NH—, CH₃CH₂NH—, CH₃(CH₂)₂NH—, CH₃(CH₂)₃NH— and glycidoxy-, a divalent functional group —NH—, or a trivalent functional group, isocyanaurato-;

each R³⁶ is independently a straight chain alkylene group of from 1 to 6 carbon atoms or a branched chain alkylene group of from 3 to 6 carbon atoms;

each R³⁷ is independently a straight chain alkyl group of from 1 to 4 carbon atoms or a branched chain alkyl group of from 3 to 4 carbon atoms; and

the subscripts n and o are integers where n is 0 or 1 and o is 1, 2 or 3, with the provisos that when monovalent, o is 1, when A³ is divalent, o is 2 and when A³ is trivalent, o is 3, and more specifically 3-aminopropyltrimethoxysilane, 3-aminopropyltriethoxysilane, N-(2-aminoethyl)-3-aminopropyltrimethoxysilane, N-ethyl 3-amino-2-methylpropyltrimethoxysilane, bis-(trimethoxysilylpropyl) amine, N, N′, N″-tris-(3-trimethoxysilylpropyl)isocyanurate, N-(2-ethyl)3-aminopropylmethyl-dimethoxysilane, 3-glycidoxypropyltrimethoxysilane, 3-glycidoxypropyltriethoxysilane, and 3-glycidoxypropylmethyldiethoxysilane; and

about 0.1 to about 3 parts by weight per 100 parts by weight of the alkoxysilyl-containing polymer (a) of a curing catalyst selected from the group consisting of organic dibutyltin, zirconium complex, aluminum chelate, titanic chelate, organic zinc, organic cobalt, organic iron, organic nickel and organobismuth, primary amine, secondary amine, tertiary amine and amino-functional alkoxysilane and mixtures thereof, and more specifically, tetra-tert-butyl orthotitanate, titanium(IV) bis(ethylacetoacetato)diisobutoxide, titanium(IV) bis(ethylacetoacetato)dimethoxide, titanium(IV) bis(ethylacetoacetato)diethoxide, titanium(IV) bis(ethylacetoacetato)monoethoxide monomethoxide, titanium(IV) bis(ethylacetoacetato)diisopropoxide, di-n-butyltin dilaurate, di-n-butyltin diacetate, di-n-butyltin oxide, di-n-butyltin dineodecanoate, di-n-butyltin diacetylacetonate, di-n-butyltin maleate, di-n-octyltin diacetate, di-n-octyltin dilaurate, di-n-octyltin oxide, di-n-octyltin maleate, di-n-octyltin di(2-ethyl)hexanoate, di-n-octyltin neodecanoate, di-n-octyltin isodecanoate, the partial hydrolysis products thereof of organic tin compounds, the partial hydrolysis products thereof of titanium compounds, and the reaction products of these organic tin compounds, titanium compounds, partial hydrolysis products of organic tin compounds or titanium compounds with tetraethoxysilane, methyltriethoxysilane, methyltrimethoxysilane, propyltrimethoxysilane, 3-aminopropyltrimethoxysilane, 3-aminopropyltriethoxysilane, 2-aminoethyl-3-aminopropyltrimethoxysilane and 2-aminoethyl-3-aminopropyltrimethoxysilane. The moisture-curable silylated polymer composition is non-yellowing, which is characterized as having a percent change in b* value, as measured by a colorimeter of from −30% to about 5%, preferably from about −20% to about 0%, and most preferably from about −15% to about 0% following a period of UV exposure under ISO 4892-2:2013 Annex B, Method B, cycle B7 of 7 days, where the percent change in b* value is determined by measuring the b* value using a colorimeter of the composition after curing and after exposure to UV light, denoted b*(UV), and measuring the b* value of after curing of the composition and before exposure to UV light, denoted as b*(initial) and then using the equation:

Percent non-yellowing value=100%×[(b*(UV)−b*(initial))/b*(initial)].

In another embodiment, a moisture-curable silylated polymer composition is provided comprising:

(a) 100 parts by weight of an alkoxysilyl-containing polymer having the general formula (I):

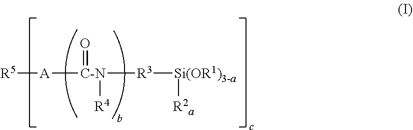

wherein

each A is independently —O— or —N(R4) or more specifically

each R¹ is methyl or ethyl or more specifically methyl;

each R² is methyl;

each R³ is methylene, propylene, 2-methylpropylene, 2,2-dimethylbutylene, or more specifically propylene;

each R⁴ is methyl, ethyl, phenyl or hydrogen, or more specifically methyl or ethyl;
R⁵ is a divalent or polyvalent group having the general formula (II):

—R⁶O(R⁷O)_{d}(R⁸O)_{c-2}[C(═O)NH—R⁰—NHC(═O)O(R⁷O)_{d}]ₘR⁶— (II)

wherein each R⁶ is independently ethylene, 2-methylethylene, 1-methylethylene or —C(═O)NH—R⁰—NHC(═O)— group, where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms or more specifically, hexylene or

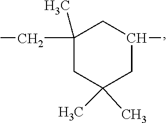

each R⁷ is independently ethylene, 2-methylethylene or 1-methylethylene, each R⁸ is

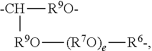

wherein each R⁹ is independently methylene, ethylene, propylene or more specifically methylene; and the subscripts a, b, c, d, e and m are integers where each a is independently 0 or 1, more specifically 0, b is 0 or 1, or more specifically 1, c is 2 or 3, or more specifically 2, d is from 20 to 400, each e is independently from 0 to 100 and m is 0 or 1, more specifically 1, with the provisos that if R⁶ is —C(═O)NH—R⁰—NHC(═O)— group, then A is —N(R⁴)— and b is 0;

(b) a UV light stabilizer package comprising:
(i) about 0.5 to about 3 parts by weight per 100 parts by weight of the alkoxysilyl-containing polymer (a) of at least one light stabilizer having the formula (III):

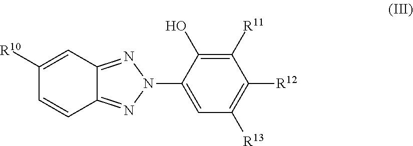

wherein

R¹⁰ is hydrogen or chloro;

R¹¹ is hydrogen, a straight chain alkyl group of from 1 to 12 carbon atoms, a branched chain alkyl group of from 3 to 12 carbon atoms, a

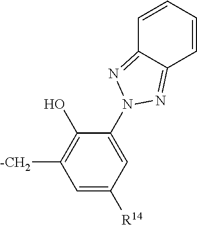

group, where R¹⁴ is a straight chain alkyl group of from 1 to 12 carbon atom or a branched chain alkyl group of from 3 to 12 carbon atoms, or an —OR¹⁵ group, where R¹⁵ is a straight chain alkyl group of from 1 to 12 carbon atoms or a branched chain alkyl group of from 3 to 12 carbon atoms;

R¹² is hydrogen, a straight chain alkyl group of from 1 to 12 carbon atoms, a branched chain alkyl group of from 3 to 12 carbon atoms or an —OR¹⁶ group, where R¹⁶ is a straight chain alkyl group of from 1 to 12 carbon atoms or a branched chain alkyl group of from 3 to 12 carbon atoms;

R¹³ is hydrogen, a straight chain alkyl group of from 1 to 12 carbon atoms, a branched chain alkyl group of from 3 to 12 carbon atoms, an —OR³⁹ group, where R³⁹ is a straight chain alkyl group of from 1 to 12 carbon atoms or a branched chain alkyl group of from 3 to 12 carbon atoms, or a —(CH₂)_{f}C(═O)O(C_{g}H_{2g}O)ₕR¹⁷, where R¹⁷ is hydrogen, a straight chain alkyl group of from 1 to 12 carbon atoms, a branched chain alkyl group of from 3 to 12 carbon atoms or a group of formula (IV):

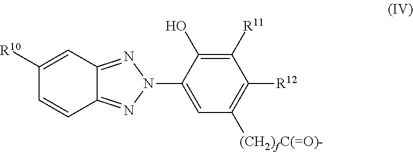

with the proviso that when R¹⁷ is the group of formula (IV), then h is 1 to 15; and

the subscripts f, g and h are integers where f is from 0 to 6, g is from 2 to 4 and h is from 0 to 15;
(ii) about 0.2 to about 1.5 parts by weight per 100 parts by weight of the alkoxysilyl-containing polymer (a) of at least one sterically hindered amine compound having the formula (VI):

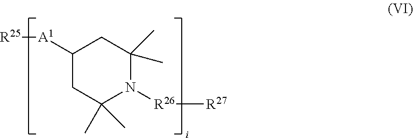

wherein

each A¹ is independently selected from the group consisting of straight chain alkenylene groups of from 1 to 10 carbon atoms, branched chain alkylene groups of from 3 to 10 carbon atoms or a chemical single bond;

each R²⁵ and R²⁷ is independently hydrogen, a straight chain alkyl group of 1 to 10 carbon atoms, a branched chain alkyl group of from 3 to 10 carbon atoms, a hydroxyl group, an amino group, —NR³⁸2, where R³⁸ is independently hydrogen, a straight chain alkyl group of from 1 to 6 carbon atoms or a branched chain alkyl group of from 3 to 6 carbon atoms;

each R²⁶ is independently a straight chain alkylene group of from 1 to 10 carbon atoms, a branched chain alkylene group of from 3 to 10 carbon atoms, arylene group of from 6 to 10 carbon atoms, aralkylene group of 7 to 10 carbon atoms or a divalent organic group of 1 to 20 carbon atoms containing at least one divalent oxygen atoms forming an ether group, a —C(═O)O— group forming an ester functional group, carbonyl group, a primary amido group, a secondary amido group, a primary amino group, a secondary amino group or tertiary amino group; and

the subscript i is an integer from 1 to 100; or sterically hindered amine compound having the formula (VII):

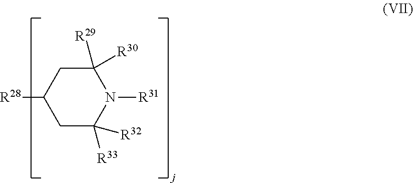

wherein

R²⁸ is hydrogen, a monovalent or polyvalent hydrocarbon group containing from 1 to 16 carbon atoms, a monovalent or polyvalent organic group of from 1 to 24 carbon atoms containing at least one triazinyl group, pyrimidinyl group, pyridinyl group, 2,4,6-trione-1,3,5-triazinyl group, divalent oxygen atoms forming an ether group, a —C(═O)O— group forming an ester functional group, carbonyl group, a primary amido group or secondary amido group, a primary amino group, a secondary amino group or tertiary amino group;

each R²⁹, R³⁰, R³² and R³³ is independently a straight chain alkyl group of from 1 to 6 carbon atoms or a branched chain alkyl group of from 3 to 6 carbon atoms;

each R³¹ is independently hydrogen, a straight chain alkyl group of from 1 to 10 carbon atoms, a branched chain alkyl group of from 3 to 10 carbon atoms, an aryl group of from 6 to 10 carbon atom or an aralkyl of from 7 to 10 carbon atoms; and

the subscript j is an integer from 1 to 5.
(iii) about 0.5 to about 5 parts by weight by weight per 100 parts by weight of the alkoxysilyl-containing polymer (a)
   of a silicon compound containing a conjugated C═C group having the general formula (VIII):

A²Si(CH₃)ₖ(OR³⁵)₃₋ₖ (VIII)

wherein

A² is phenyl

R³⁵ is methyl or ethyl or more specifically methyl; and

k is an integer 0 or 1 or more specifically 0;

(c) about 0.5 to about 5 parts by weight per 100 parts by weight of the alkoxysilyl-containing

polymer (a) of an adhesion promoter containing an alkoxysilyl group having the general formula (XVI):

A³[R³⁶—Si(CH₃)ₙ(OR³⁷)₃₋ₙ]ₒ (XVI)

wherein

A³ is a monovalent functional group selected from H₂N—, H₂NCH₂CH₂NH—, CH₃NH—, CH₃CH₂NH—, CH₃(CH₂)₂NH—, CH₃(CH₂)₃NH— and glycidoxy-, a divalent functional group —NH—, or a trivalent functional group, isocyanaurato-;

each R³⁶ is independently a straight chain alkylene group of from 1 to 6 carbon atoms or a branched chain alkylene group of from 3 to 6 carbon atoms;

each R³⁷ is independently a straight chain alkyl group of from 1 to 4 carbon atoms or a branched chain alkyl group of from 3 to 4 carbon atoms; and

the subscripts n and o are integers where n is 0 or 1 and o is 1, 2 or 3, with the provisos that when monovalent, o is 1, when A³ is divalent, o is 2 and when A³ is trivalent, o is 3, and more specifically 3-aminopropyltrimethoxysilane, 3-aminopropyltriethoxysilane, N-(2-aminoethyl)-3-aminopropyltrimethoxysilane, N-ethyl 3-amino-2-methylpropyltrimethoxysilane, bis-(trimethoxysilylpropyl) amine, N, N′, N″-tris-(3-trimethoxysilylpropyl)isocyanurate, N-(2-ethyl)3-aminopropylmethyl-dimethoxysilane, 3-glycidoxypropyltrimethoxysilane, 3-glycidoxypropyltriethoxysilane, and 3-glycidoxypropylmethyldiethoxysilane; and

(d) about 0.1 to about 3 parts by weight per 100 parts by weight of the alkoxysilyl-containing polymer (a) of a curing catalyst selected from the group consisting of organic dibutyltin, zirconium complex, aluminum chelate, titanic chelate, organic zinc, organic cobalt, organic iron, organic nickel and organobismuth, primary amine, secondary amine, tertiary amine and amino-functional alkoxysilane and mixtures thereof, and more specifically, tetra-tert-butyl orthotitanate, titanium (IV) bis(ethylacetoacetato)diisobutoxide, titanium(IV) bis(ethylacetoacetato)dimethoxide, titanium (IV) bis(ethylacetoacetato)diethoxide, titanium (IV) bis(ethylacetoacetato)monoethoxide monomethoxide, titanium (IV) bis(ethylacetoacetato)diisopropoxide, di-n-butyltin dilaurate, di-n-butyltin diacetate, di-n-butyltin oxide, di-n-butyltin dineodecanoate, di-n-butyltin diacetylacetonate, di-n-butyltin maleate, di-n-octyltin diacetate, di-n-octyltin dilaurate, di-n-octyltin oxide, di-n-octyltin maleate, di-n-octyltin di(2-ethyl)hexanoate, di-n-octyltin neodecanoate, di-n-octyltin isodecanoate, the partial hydrolysis products thereof of organic tin compounds, the partial hydrolysis products thereof of titanium compounds, and the reaction products of these organic tin compounds, titanium compounds, partial hydrolysis products of organic tin compounds or titanium compounds with tetraethoxysilane, methyltriethoxysilane, methyltrimethoxysilane, propyltrimethoxysilane, 3-aminopropyltrimethoxysilane, 3-aminopropyltriethoxysilane, 2-aminoethyl-3-aminopropyltrimethoxysilane and 2-aminoethyl-3-aminopropyltrimethoxysilane. The moisture-curable silylated polymer composition is a non-yellowing composition characterized by a percent change in b* value, as measured by a colorimeter of from −30% to about 5%, preferably from about −20% to about 0%, and most preferably from about −15% to about 0% following a period of UV exposure under ISO 4892-2:2013 Annex B, Method B, cycle B7 of 7 days, where the percent change in b* value is determined by measuring the b* value using a colorimeter of the composition after curing and after exposure to UV light, denoted b*(UV), and measuring the b* value of after curing of the composition and before exposure to UV light, denoted as b*(initial) and then using the equation:

Percent non-yellowing value=100%×[(b*(UV)−b*(initial))/b*(initial)].

As noted above, the use of the silicon-compound having a conjugated structure in conjunction with the liquid UV absorber provides for a decrease or avoidance of any yellowing in the moisture-curable composition, and preferably, the moisture composition is optically clear. Preferably, the moisture-curable composition has an amount of yellowing following exposure to UV light which is less than an identical moisture-curable composition which is in the absence of silicon-compound having a conjugated structure. The amount of yellowing, if any, or a decrease thereto, can be determined by visual inspection and/or by the use of a colorimeter of the cured composition, before and/or after exposure of the cured composition to ultra-violet light, for example after exposure to sunlight, for a period of time of from about 1 hour to about 1 year, preferably from about 1 day to about 6 months, and most preferably from about one month to about 3 months.

There is also provided herein a method of making the moisture-curable composition comprising mixing the alkoxysilyl-containing polymer (a) with the UV light stabilizer package (b) comprising (i) at least one light stabilizer, (ii) at least sterically hindered amine, and (iii) a silicon-containing compound containing a conjugated C═C group, at least one adhesion promoter (c) and at least one curing catalyst (d), as well as with any optional other materials described herein. The mixing can be conducted with conventional equipment as will be known by those skilled in the art. The addition of the components (a) to (d), and any optional components, can be conducted simultaneously, or with any permutation or combination of methods of addition of these components.

The moisture-curable silylated polymer compositions of this invention may be used in preparing sealant or adhesive formulations, or in coating applications or caulking or sealing applications that are used in buildings, airplanes, bathroom fixtures or automotive equipment. Another desirable feature of these moisture-curable silylated polymer compositions is their ability to be applied to moist or wet surfaces and be cured into a cross-linked elastomer without deleterious effects, which cured product becomes tack-free within a relatively short period of time. Moreover, the cured composition of this invention strongly adhere alone or with the aid of a primer to a wide variety of substrates such as glass, porcelain, wood, metals, polymeric materials and the like making them especially suited for any type of caulking, adhesive or laminating applications.

In one embodiment, the transparency of the moisture-curable silylated polymer after curing is from 85 to 100 and the haze is from 0 to 50, as measured in accordance with ASTM D-1003-Standard Test Method for Haze and Luminous Transmittance of Transparent Plastics.

While the invention has been described with reference to a number of embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to any particular embodiment disclosed herein.

### EXAMPLES

The following nonrestrictive examples are further illustrative of the invention.

### Preparation of Alkoxysilyl-Containing Polymer (a)

Into a 1-liter resin kettle were charged 400 grams of dried hydroxy-terminated polypropylene oxide (obtained from Zhejiang Huangma Chemical under the tradename HMBT-120, hydroxyl number of 9.93 mg KOH/gram), 2 grams of benzenepropanoic acid, 3,5-bis (1,1-dimethyl-ethyl)-4-hydroxy-C7-C9 branched alkyl esters (obtained from BASF under the tradename Irganox® 1135) and 10 ppm of dibutyltin dilaurate (obtained from Momentive Performance Materials, Inc. under the tradename Formez SUL-4) and heated up to 40° C. with agitation and a nitrogen blanket. Isophorone diisocyanate (3.76 grams, 0.0169 mole, obtained from Covestro under the tradename Desmodur®, 0.0169 mol) was added into the kettle. The reaction mixture was heated to a temperature of from 70° C. to 75° C. The reaction was monitored by measuring the isocyanate content. When the NCO content was near zero, as measured by titration, 7.08 grams of 3-isocyanatopropyltrimethoxysilane (0.0339 mole, obtained from Momentive Performance Materials, Inc. under the tradename A-Link 35 silane) was added. The mixture was heated to approximately 83° C. until the NCO content was near zero by titration, then the heat was turned off and 0.3 grams of methanol and 0.39 grams of vinyltrimethoxysilane (obtained from Momentive Performance Materials, Inc. under the tradename Silquest® A-171 silane) were added.

### Examples 1 to 5 and Comparative Examples I to V

### Clear, Transparent, Low Yellow Colored and Non-Yellowing Moisture-Curable Silylated Polymer Compositions and Comparative Compositions

Into a mixer were charged the alkoxysilyl-containing polymer (a) prepared above, a desiccant, the light stabilizer (b)(i) and the sterically hindered amine (b)(ii). The components were mixed in a speed mixer at 27,500 rpm for 1 minute. The plasticizer and rheology modifier were added and mixed at 27,500 rpm for 2 minutes. The lid on the mixer was opened and the mixture was scraped down from the walls and mixed again. The scraping and mixing steps were repeated three times or until the mixture was homogeneous. The silicon compound containing C═C group (b)(iii), if present, or the other silicon compounds if present and the adhesion promoter (c) were added and mixed at 27,000 rpm for 2 minutes. Finally, the curing catalyst (d) was added and mixed at 27,000 rpm for 1 minute. The amounts of the ingredients are presented in Table 1. Film was cast and cured for testing.

Table 1. The ingredients and amounts of each compound for Examples 1 to 5 and Comparative Examples I to V are presented.

TABLE 1

| | Example | Example | Example | Example | Example |
|---|---|---|---|---|---|
| Ingredient | 1 | 2 | 3 | 4 | 5 |
| ¹Alkoxy silyl-containing | 100 | 100 | 100 | 100 | 100 |
| polymer (a), parts | | | | | |
| ²Light stabilizer (b)(i)(1), | | 1.00 | 1.00 | | |
| parts | | | | | |
| ³Light stabilizer (b)(i)(2), | | | | 1.00 | 1.00 |
| parts | | | | | |
| ⁴Light stabilizer (b)(i)(3), | 1.00 | | | | |
| parts | | | | | |
| ⁵Sterically hindered | 0.50 | 0.50 | 0.50 | | |
| amine (b)(ii)(1), parts | | | | | |
| ⁶Sterically hindered | | | | 0.50 | 0.50 |
| amine (b)(ii)(2), parts | | | | | |
| ⁷Silicon-containing | 1.85 | | 1.85 | | 1.85 |
| compound (b)(iii)(1), | | | | | |
| parts | | | | | |
| ⁸Silicon-containing | | 1.85 | | 1.85 | |
| compound (b)(iii)(2), | | | | | |
| parts | | | | | |
| ⁹Adhesion promoter | 2.22 | 2.22 | 2.22 | | |
| (c)(1), parts | | | | | |
| ¹⁰Adhesion promoter | | | | 2.22 | 2.22 |
| (c)(2), parts | | | | | |
| ¹¹during catalyst (d)(1), | 0.54 | 0.54 | 0.54 | 0.54 | 0.54 |
| parts | | | | | |
| ¹²Other silicon compound | | | | | |
| (1), parts | | | | | |
| ¹³Other silicon compound | | | | | |
| (2), parts | | | | | |
| ¹⁴Other silicon compound | | | | | |
| (3), parts | | | | | |
| ¹⁵Other silicon compound | | | | | |
| (4), parts | | | | | |
| ¹⁶Desiccant, | 2.04 | 2.04 | 2.04 | 2.04 | 2.04 |
| vinyltrimethoxysilane, | | | | | |
| parts | | | | | |
| ¹⁷Rheology modifier, | 16.33 | 16.33 | 16.33 | 16.33 | 16.33 |
| parts | | | | | |
| ¹⁸Plasticizer, parts | 60.70 | 60.70 | 60.70 | 60.70 | 60.70 |

| | Comp. | Comp. | Comp. | Comp. | Comp. |
|---|---|---|---|---|---|
| Ingredient | Ex. I | Ex. II | Ex. III | Ex. IV | Ex. V |
| ¹Alkoxy silyl-containing | 100 | 100 | 100 | 100 | 100 |
| polymer (a), parts | | | | | |
| ²Light stabilizer (b)(i)(1), | | 1.00 | | | |
| parts | | | | | |
| ³Light stabilizer (b)(i)(2), | | | 1.00 | 1.00 | 1.00 |
| parts | | | | | |
| ⁴Light stabilizer (b)(i)(3), | 1.00 | | | | |
| parts | | | | | |
| ⁵Sterically hindered | 0.50 | 0.50 | | | |
| amine (b)(ii)(1), parts | | | | | |
| ⁶Sterically hindered | | | | 0.50 | 0.50 |
| amine (b)(ii)(2), parts | | | | | |
| ⁷Silicon-containing | | | | | |
| compound (b)(iii)(1), | | | | | |
| parts | | | | | |
| ⁸Silicon-containing | | | | | |
| compound (b)(iii)(2), | | | | | |
| parts | | | | | |
| ⁹Adhesion promoter | 2.22 | 2.22 | 2.22 | | |
| (c)(1), parts | | | | | |
| ¹⁰Adhesion promoter | | | | 2.22 | 2.22 |
| (c)(2), parts | | | | | |
| ¹¹Curing catalyst (d)(1), | 0.54 | 0.54 | 0.54 | 0.54 | 0.54 |
| parts | | | | | |
| ¹²Other silicon compound | 1.85 | 1.85 | | | |
| (1), parts | | | | | |
| ¹³Other silicon compound | | | 1.85 | | |
| (2), parts | | | | | |
| ¹⁴Other silicon compound | | | | 1.85 | |
| (3), parts | | | | | |
| ¹⁵Other silicon compound | | | | | 1.85 |
| (4), parts | | | | | |
| ¹⁶Desiccant, | 2.04 | 2.04 | 2.04 | 2.04 | 2.04 |
| vinyltrimethoxysilane, | | | | | |
| parts | | | | | |
| ¹⁷Rheology modifier (1), | 16.33 | 16.33 | 16.33 | 16.33 | 16.33 |
| parts | | | | | |
| ¹⁸Plasticizer, parts | 60.70 | 60.70 | 60.70 | 60.70 | 60.70 |

¹Alkoxysilyl-containing polymer (a) prepared above.
²Light stabilizer (b)(i)(1): a mixture of poly(oxy-1,2-ethanediyl), α-(3-(3-(2H-benzotriazol-2-yl)-5-(1,1-dimethylethyl)-4-hydroxyphenyl)-1-oxopropyl)-ω-hydroxy (CAS# 104810-48-2) and poly(oxy-1,2-ethanediyl), α-(3-(3-(2H-benzotriazol-2-yl)-5-(1,1-dimethylethyl)-4-hydroxyphenyl)-1-oxopropyl-ω-(3-(3-(2H-benzotriazol-2-yl-5-(1,1-dimethylethyl)-4-hydroxyphenyl)-1-oxopropoxy) (CAS# 104810-48-1), obtained from BASF under the tradename Tinuvin ® 213;
³Light stabilizer (b)(i)(2):- a mixture of poly(oxy-1,2-ethanediyl), α-(3-(3-(2H-benzotriazol-2-yl)-5-(1,1-dimethylethyl)-4-hydroxyphenyl)-1-oxopropyl)-ω-hydroxy (CAS# 104810-48-2) and poly(oxy-1,2-ethanediyl), α-(3-(3-(2H-benzotriazol-2-yl)-5-(1,1-dimethylethyl)-4-hydroxyphenyl)-1-oxopropyl-ω -(3-(3-(2H-benzotriazol-2-yl-5-(1,1-dimethylethyl)-4-hydroxyphenyl)-1-oxopropoxy) (CAS# 104810-48-1), and polyethylene glycol 300 CAS# 25322-68-3 (PEG 300), obtained from Everlight Chemical under the tradename Eversorb ® 80;
⁴Light stabilizer (b)(i)(3):_N-(2-Ethoxyphenyl)-N-(4-ethylphenyl)-ethlyenediamide (CAS# 23949-66-8), obtained from BASF under the tradename Tinuvin ® 312;
⁵Sterically hindered amine (b)(ii)(1): a mixture of bis-(N-methyl-2,2,6,6-tetramethyl-4-piperidinyl) sebacate (CAS# 41556-26-7) and methyl-(N-methyl-2,2,6,6-tetramethyl-4-piperidinyl) sebacate. CAS# 82919-37-7, obtained from BASF under the tradename Tinuvin ® 292;
⁶Sterically hindered amine (b)(ii)(2): a mixture of bis-(N-methyl-2,2,6,6-tetramethyl-4-piperidinyl) sebacate (CAS# 41556-26-7 and methyl-(N-methyl-2,2,6,6-tetramethyl-4-piperidinyl) sebacate. CAS# 82919-37-7, obtained from Everlight Chemical under the tradename Eversorb ® 93;
⁷Silicon-containing compound (b)(iii)(1): phenyltrimethoxysilane, obtained from Gelest;
⁸Silicon-containing compound (b)(iii)(2): 3-methacryloxypropyltrimethoxysilane, obtained from Momentive Performance Materials under the tradename Silquest ® A-174 silane;
⁹Adhesion promoter (c)(1): 3-aminopropyltrimethoxysilane, obtained from Momentive Performance Materials, Inc. under the tradename Silquest ® A-1110 silane;
¹⁰Adhesion promoter (c)(3): 4-amino-3,3-dimethylbutylttimethoxysilane, obtained from Momentive Performance Materials, Inc under the tradename A-Link ® 600 silane;
¹¹Curing catalyst (d)(1): dioctyltin dilaurate, obtained from Momentive Performance Materials, Inc. under the tradename Fomrez ® UL-59 catalyst;
¹²Other silicon compound (1): methyltrimethoxysilane, obtained from Momentive Performance Materials, Inc. under the tradename Silquest ® A-1630 silane;
¹³Other silicon compound (2): a methyl phenyl resin, obtained from Momentive Performance Materials, Inc. under the tradename TSR 165;
¹⁴Other silicon compound (3): a poly(dimethylsiloxy-diphenylsiloxy) copolymer, obtained from Momentive Performance Materials, Inc. under the tradename CoatOSil FLEX;
¹⁵Other silicon compound (4): A silicone resin available from Momentive Performance Materials, Inc. under the tradename XR31-B1410;
¹⁶Desiccant: vinyltrimethoxysilane, available from Momentive Performance Materials, Inc. under the tradename Silquest ® A-171 silane;
¹⁷Rheology modifier: hydrophobic fumed silica, obtained from Evonik under the tradename Aerosil ® R 812S; and
¹⁸Plasticizer: diisononyl adipate, obtained from ExxonMobil under the tradename Jayflex ® DINA.

### Test Methods

Mechanical Properties:

The above clear sealant formulations were cast into HDPE molds to form films having thicknesses of about 2.5 mm. The films were cured in a humidity chamber at 23 C and 50% RH for 7 days. The films were removed from the mold and ready for testing.

The UV resistance test: The cured specimens were exposed to Xenon-arc lamps in a Q-Sun Xenon test chamber according to ISO 4892-2:2013 Annex B Method B cycle B7 for 7 days. The yellowing and mechanical properties were tested before and after the Xenon exposure.

Test mechanical properties—The tension properties were tested following ASTM D412 and ASTM C661 for determining Shore A hardness. The mechanical properties were tested before and after exposure to Xenon lights.

Measure the yellow coloration—The specimens were tested using DIE-LAB by Minolta colorimeter (L*a*b*). The Minolta white calibration plate has a b* value of ˜4.25. The cured clear sealant sheet was placed on the top of white calibration plate to measure the color. The b value was recorded and compared before and after exposure in Xenon test chamber.

Adhesion on different substrates: Adhesion was determined with a modified version of ASTM C-794, 180° peel test. Each peel specimen contained two 1″ wide metal mesh strips imbedded into the sealant. The specimens were cured in a humidity chamber at 23 C and 50% RH for three weeks. The peel specimens were then cut along the 1″ wide metal mesh strips and mounted on Instron. The crosshead speed for the 180° peel test is two inches per minute. Each sample was pulled approximately two inches and the peel strength and mode of failure was observed, whether cohesive or adhesive failure.

The test results are presented in Table 2.

TABLE 2
The test results for Examples 1 to 5 and Comparative Examples I to V are presented.

| | Example | Example | Example | Example | Example |
|---|---|---|---|---|---|
| Color properties | 1 | 2 | 3 | 4 | 5 |
| initial yellow color, b* | 4.95 | 4.35 | 4.73 | 3.40 | 4.11 |
| (L*a*b*) | | | | | |
| Percent non-yellowing value | −25.9% | −15.3% | −8.9% | 4.7% | −13.9% |

Mechanical properties

| | | | | | |
|---|---|---|---|---|---|
| Initial (before UV exposure) | | | | | |
| Tensile Strength @ BK | 134 | 137 | 129 | 128 | 135 |
| (psi) | | | | | |
| Elongation @ BK(%) | 253 | 243 | 243 | 209 | 183 |
| Modules @ 100% extension | 52 | 56 | 54 | 61 | 75 |
| (psi) | | | | | |
| Hardness Shore A | 19 | 20 | 16 | 24 | 24 |

after 7 days at Xenon

| | | | | | |
|---|---|---|---|---|---|
| Tensile Strength @ BK | 151.9 | 141.6 | 142.4 | 134.3 | 156.5 |
| (psi) | | | | | |
| Elongation @ BK (%) | 389.3 | 309.9 | 342.7 | 263.2 | 255.5 |
| Modules @ 100% extension | 41.6 | 49.1 | 47.1 | 55.6 | 67.0 |
| (psi) | | | | | |
| Hardness Shore A | 19 | 20 | 16 | 24 | 24 |

180 degree peel (ASTM C794, unit: lbs/in/% CF)

| | | | | | |
|---|---|---|---|---|---|
| Glass | 19/100 | 19/100 | 19/95 | 10/100 | 9/100 |
| Anodized Aluminum | 13/100 | 15/100 | 21/100 | 0/0 | 0/0 |
| Lexan | 19/70 | 12/100 | 17/100 | 9/100 | 7/100 |

| | Comp. | Comp. | Comp. | Comp. | Comp. |
|---|---|---|---|---|---|
| Color properties | Ex. I | Ex. II | Ex. III | Ex. IV | Ex. V |
| initial yellow color, b* | 2.91 | 3.79 | 5.50 | 6.80 | 6.70 |
| (L*a*b*) | | | | | |
| Percent non-yellowing value | 11.2% | 12.1% | 42% | 32% | 45% |

Mechanical properties

| | | | |
|---|---|---|---|
| Initial (before UV exposure) | | | |
| Tensile Strength @ BK | 150 | 153 | — |
| (psi) | | | |
| Elongation @ BK(%) | 219 | 249 | |
| Modules @ 100% extension | 67 | 61 | |
| (psi) | | | |
| Hardness Shore A | 22 | 22 | |

after 7 days at Xenon

| | | | | | |
|---|---|---|---|---|---|
| Tensile Strength @ BK | 152.1 | 155.6 | 147 | 176 | 156 |
| (psi) | | | | | |
| Elongation @ BK (%) | 307.9 | 323.7 | 199 | 244 | 190 |
| Modules @ 100% extension | 53.1 | 51.9 | 59 | 52 | 64 |
| (psi) | | | | | |
| Hardness Shore A | 22 | 22 | 20 | 19 | 21 |

180 degree peel (ASTM C794, unit: lbs/in/% CF)

| | | | | | |
|---|---|---|---|---|---|
| Glass | 13/100 | 15/95 | 12.2/100 | 14/100 | 7.3/100 |
| Anodized Aluminum | 10/50 | 16/100 | 13.4/100 | 10.7/100 | 8.4/100 |
| Lexan | 14/100 | 12/100 | 1.5/0 | 13.4/100 | 7.5/100 |

The data from Examples 1 to 5 demonstrate the advantage of using the silicon compounds containing a conjugated C═C group (b)(iii). For example, Example 1 used phenyltrimethoxysilane had a percent non-yellowing value of −25.9. After exposure to the UV radiation, the sample become less yellow. However, Comparative Example 1, which was a very similar formulation, except that the phenyltrimethoxysilane was replace with an equal amount of methyltrimethoxysilane had a percent non-yellowing value of 11.2, which indicated that the cured composition become more yellow upon exposure to UV radiation. Examples 3 and 5, which also used phenyltrimethoxysilane as the silicon compounds containing a conjugated C═C group (b)(iii), but with different light stabilizer (b)(i), sterically hindered amine (b)(ii) and/or adhesion promoter (c) had percent non-yellowing value of −8.9% and −13.9%, indicating that the cured compositions became less yellow after exposure to UV radiation. When the silicon compounds containing a conjugated C═C group (b)(iii) was 3-methacryloxypropyltrimethoxysilane, such as for example, Example 2, the percent non-yellowing value was −15.3, indicating that this compound was an effective component in the UV light stabilizer package. Comparative Examples 1, which contained a silicon compound absent the conjugated C═C group, did not provide the same level of non-yellowing benefit.

### Examples 6 to 8 and Comparative Example VI

### Clear, Transparent, Low Yellow Colored and Non-Yellowing Moisture-Curable Silylated Polymer Compositions and Comparative Composition

Examples 6 to 8 and Comparative Example VI were prepared in according the procedure of Example 1. The compositions of the compositions are presented in Table 3 and the results in Table 4. The transparency and haze were determined using a Haze Gard PLUS instrument available from BYK Gardner.

TABLE 3
The ingredients and amounts of each compound for Examples
1 to 5 and Comparative Examples I to V arc presented.

| | Comp. | Example | Example | Example |
|---|---|---|---|---|
| Ingredient | Ex. VI | 6 | 7 | 4 |
| ¹⁹Alkoxysilyl-containing | 100 | 100 | 100 | 100 |
| polymer (a), parts | | | | |
| ²⁰Light stabilizer (b)(i)(1), | 1.00 | 1.00 | 1.00 | 1.00 |
| parts | | | | |
| ²¹Sterically hindered | 0.50 | 0.50 | 0.5 | 0.5 |
| amine (b)(ii)(1), parts | | | | |
| ²²Silicon-containing | | | 1.85 | 1.85 |
| compound (b)(iii)(1), | | | | |
| parts | | | | |
| ²³Silicon-containing | | 1.85 | | |
| compound (b)(iii)(2), | | | | |
| parts | | | | |
| ²⁴Adhesion promoter | 2.22 | 2.22 | 2.22 | |
| (c)(1), parts | | | | |
| ²⁵Adhesion promoter | | | | 2.22 |
| (c)(2), parts | | | | |
| ²⁶Curing catalyst (d)(1), | 0.54 | 0.54 | 0.54 | 0.54 |
| parts | | | | |
| ²⁷Other silicon compound | 1.85 | | | |
| (5), parts | | | | |
| ²⁸Desiccant, | 2.04 | 2.04 | 2.04 | 2.04 |
| vinyltrimethoxysilane, | | | | |
| parts | | | | |
| ²⁹Rheology modifier (1), | | | 16.33 | 16.33 |
| parts | | | | |
| ³⁰Rheology modifier (2) | 16.33 | 16.33 | | |
| ³¹Plasticizer, parts | 60.70 | 60.70 | 60.70 | 60.70 |

¹⁹Alkoxysilyl-containing polymer (a) prepared above.
²⁰Light stabilizer (b)(i)(1): a mixture of poly(oxy-1,2-ethanediyl), α-(3-(3-(2H-benzotriazol-2-yl)-5-(1,1-dimethylethyl)-4-hydroxyphenyl)-1-oxopropyl)-ω-hydroxy (CAS#104810-48-2) and poly(oxy-1,2-ethanediyl), α-(3-(3-(2H-bcnzotriazol-2-yl)-5-(1,1-dimethylethyl)-4-hydroxyphenyl)-1-oxopropyl-ω-(3-(3-(2H-benzotriazol-2-yl-5-(1,1-dimethylethyl)-4-hydroxyphenyl)-1-oxopropoxy) (CAS# 104810-48-1), obtained from BASF under the tradename Tinuvin ® 213;
²¹Sterically hindered amine (b)(ii)(1): a mixture of bis-(N-methyl-2,2,6,6-tetramethyl-4-piperidinyl) sebacate (CAS# 41556-26-7) and methyl-(N-methyl-2,2,6,6-tetramethyl-4-piperidinyl) sebacate. CAS# 82919-37-7, obtained from BASF under the tradename Tinuvin ® 292;
²²Silicon-containing compound (b)(iii)(1): phenyltrimethoxysilane, obtained from Gelest;
²³Silicon-containing compound (b)(iii)(2): 3-methacryloxypropyltrimethoxysilane, obtained from Momentive Performance Materials under the tradename Silquest ® A-174 silane;
²⁴Adhesion promoter (c)(1): 3-aminopropyltrimethoxysilane, obtained from Momentive Performance Materials, Inc. under the tradename Silquest ® A-1110 silane;
²⁵Adhesion promoter (c)(3): 4-amino-3,3-dimethylbutyltrimethoxysilane, obtained from Momentive Performance Materials, Inc under the tradename A-Link ® 600 silane;
²⁶Curing catalyst (d)(1): dioctyltin dilaurate, obtained from Momentive Performance Materials, Inc. under the tradename Fomrez ® UL-59 catalyst;
²⁷Other silicon compound (5): 3-ureidopropyltrimethoxysilane, obtained from Momentive Performance Materials, Inc. under the tradename Silquest ® A-1524 silane;
²⁸Desiccant: vinyltrimethoxysilane, available from Momentive Performance Materials, Inc. under the tradename Silquest ® A-171 silane;
²⁷Rheology modifier: hydrophobic fumed silica, obtained from Evonik under the tradename Aerosil ® R 812S;
³⁰Rheology modifier: hydrophobic fumed silica, obtained from Cabot under the tradename Cab-O-Sil ® Ultrabond;
³¹Plasticizer: diisononyl adipate, obtained from ExxonMobil under the tradename Jayflex ® DINA

TABLE 4
The test results for Examples 6 to 8 and
Comparative Example VI are presented.

| | Comp. | Example | Example | Example |
|---|---|---|---|---|
| Color properties | Ex. VI | 6 | 7 | 8 |
| initial yellow color, b* | 8.4 | 5.4 | 7.5 | 5.5 |
| (L*a*b*) | | | | |
| Initial transparency | 82.2 | 90.8 | 87.5 | 90.3 |
| Initial haze | 77.9 | 42.2 | 36.7 | 41.2 |
| Transparency after | 81.2 | 90.6 | 86.3 | 90 |
| exposure to UV radiation | | | | |
| for 168 hours | | | | |
| Haze after exposure to UV | 76 | 35.5 | 44.2 | 43.5 |
| radiation for 168 hours | | | | |

These data demonstrated that the initial transparency of Examples 6 to 8 ranged from 87.5 to 90.8, while Comparative Example VI was 82.2. The initial haze of Examples 6 to 8 ranged from 36.7 to 42.2, while Comparative Example VI was 77.9 (higher number is indicative of a hazier and less clear cured composition). The exposure to UV radiation for 168 hours did not significantly alter the values.

Surprisingly and unexpectedly, the presence of silicon compounds containing conjugated C═C groups, but were oligomeric or polymeric, such as Comparative Example III, which contained a phenylmethylsiloxy repeat unit, or Comparative Example IV, which contained a diphenylsiloxy repeat unit, had poor non-yellowing properties. The percent non-yellowing value were 42% and 32% for Comparative Example III and IV, respectively.

1. A moisture-curable silylated polymer composition comprising:
(a) an alkoxysilyl-containing polymer having the general formula (I): 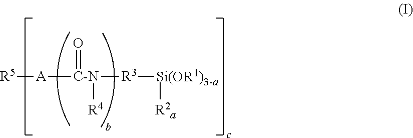
wherein
each A is independently —O— or —N(R⁴);
each R¹ is independently a straight chain alkyl group of from 1 to 4 carbon atoms or a branched chain alkyl group of 3 or 4 carbon atoms;
each R² is independently methyl or phenyl:
each R³ is independently a straight chain alkylene group of from 1 to 6 carbon atoms or a branched chain alkylene group of from 3 to 6 carbon atoms;
each R⁴ is independently hydrogen, a straight chain alkyl group of from 1 to 6 carbon atoms, a branched chain alkyl group of from 3 to 6 carbon atoms, a cycloalkyl group of from 5 to 8 carbon atoms, a phenyl group or a —R³—Si(R²)ₐ(OR¹)₃₋ₐ group;
R⁵ is a divalent or polyvalent group having the general formula (II):
—R⁶O(R⁷O)_{d}(R⁸O)_{c-2}[C(═O)NH—R⁰—NHC(═O)O(R⁷O)_{d}]ₘR⁶— (II)
wherein each R⁶ is independently a straight chain alkylene group of from 2 to 6 carbon atoms, a branched chain alkylene group of from 3 to 6 carbon atoms or a —C(═O)NH—R⁰—NHC(═O)— group, where R⁰ is a straight chain alkylene group of from 1 to 10 carbon atoms, a branched chain alkyl group of from 3 to 10 carbon atoms, a cycloalkylene group of from 6 to 16 carbon atoms, an arylene group of from 6 to 10 carbon atoms, arenylene group of from 7 to 16 carbon atoms or an aralkylene group of from 7 to 16 carbon atoms, each R⁷ is independently a straight chain alkylene group of from 2 to 6 carbon atoms or a branched chain alkylene group of from 3 to 6 carbon atoms, each R⁸ is 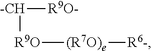
wherein each R⁹ is independently a straight chain alkylene group of from 1 to 5 carbon atoms or a branched chain alkylene group of from 3 to 5 carbon atoms; and the subscripts a, b, c, d, e and m are integers wherein each a is independently 0 or 1, b is 0 or 1, c is 2 or 3, each d is independently from 20 to 400, each e is independently from 0 to 100 and m is 0 or 1, with the provisos that if R⁶ is —C(═O)NH—R⁰—NHC(═O)— group, then A is —N(R⁴)— and b is 0;
(b) a UV light stabilizer package comprising:
(i) (a) at least one light stabilizer having the formula (III): 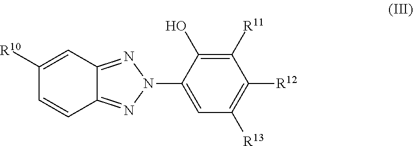
wherein
R¹⁰ is hydrogen or chloro group;
R¹¹ is hydrogen, a straight chain alkyl group of from 1 to 12 carbon atoms, a branched chain alkyl group of from 3 to 12 carbon atoms, a 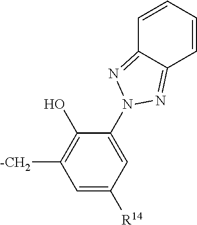
group, wherein R¹⁴ is a straight chain alkyl group of from 1 to 12 carbon atom or a branched chain alkyl group of from 3 to 12 carbon atoms, or an —OR¹⁵ group, where R¹⁵ is a straight chain alkyl group of from 1 to 12 carbon atoms or a branched chain alkyl group of from 3 to 12 carbon atoms;
R¹² is hydrogen, a straight chain alkyl group of from 1 to 12 carbon atoms, a branched chain alkyl group of from 3 to 12 carbon atoms or an —OR¹⁶ group, where R¹⁶ is a straight chain alkyl group of from 1 to 12 carbon atoms or a branched chain alkyl group of from 3 to 12 carbon atoms;
R¹³ is hydrogen, a straight chain alkyl group of from 1 to 12 carbon atoms, a branched chain alkyl group of from 3 to 12 carbon atoms, an —OR³⁹ group, where R³⁹ is a straight chain alkyl group of from 1 to 12 carbon atoms or a branched chain alkyl group of from 3 to 12 carbon atoms, or a —(CH₂)_{f}C(═O)O(C_{g}H_{2g}O)ₕR¹⁷, where R¹⁷ is hydrogen, a straight chain alkyl group of from 1 to 12 carbon atoms, a branched chain alkyl group of from 3 to 12 carbon atoms or a group of formula (IV): 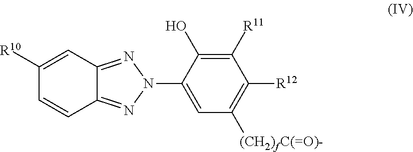
and
the subscripts f, g and h are integers where f is from 0 to 6, g is from 2 to 4 and h is from 0 to 15, with the proviso that when R¹⁷ is the group of formula (IV), then h is 1 to 15; or
(i) (b) a light stabilizer having the formula (V): 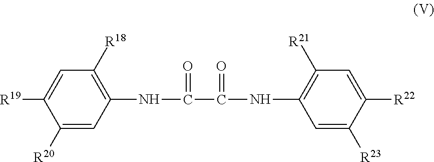
wherein each R¹⁸, R¹⁹, R²⁰, R²¹, R²² and R²³ is independently hydrogen, a straight chain alkyl group of from 1 to 16 carbon atoms, a branched chain alkyl group of from 3 to 16 carbon atoms or an —OR²⁴, where each R²⁴ is independently a straight chain alkyl group of from 1 to 16 carbon atoms or a branched chain alkyl group of from 3 to 16 carbon atoms; and
(ii) (a) at least one sterically hindered amine compound having the formula (VI): 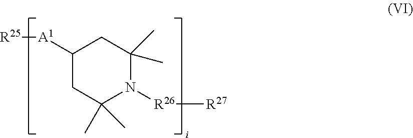
wherein
each A¹ is independently selected from the group consisting of straight chain alkenylene groups of from 1 to 10 carbon atoms, branched chain alkylene groups of from 3 to 10 carbon atoms and a single chemical bond;
each R²⁵ and R²⁷ is independently hydrogen, a straight chain alkyl group of 1 to 10 carbon atoms, a branched chain alkyl group of from 3 to 10 carbon atoms, a hydroxyl group, an amino group, —NR³⁸2, where R³⁸ is independently hydrogen, a straight chain alkyl group of from 1 to 6 carbon atoms or a branched chain alkyl group of from 3 to 6 carbon atoms;
each R²⁶ is independently a straight chain alkylene group of from 1 to 10 carbon atoms, a branched chain alkylene group of from 3 to 10 carbon atoms, arylene group of from 6 to 10 carbon atoms, aralkylene group of 7 to 10 carbon atoms or a divalent organic group of 1 to 20 carbon atoms containing at least one divalent oxygen atoms forming an ether group, a —C(═O)O— group forming an ester functional group, carbonyl group, a primary amido group, a secondary amido group, a primary amino group, a secondary amino group or tertiary amino group; and
the subscript i is an integer from 1 to 100; or
(ii) (b) a sterically hindered amine compound having the formula (VII): 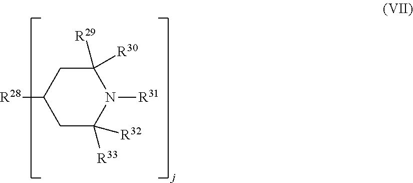
wherein
R²⁸ is hydrogen, a monovalent or polyvalent hydrocarbon group containing from 1 to 16 carbon atoms, a monovalent or polyvalent organic group of from 1 to 24 carbon atoms containing at least one triazinyl group, pyrimidinyl group, pyridinyl group, 2,4,6-trione-1,3,5-triazinyl group, divalent oxygen atoms forming an ether group, a —C(═O)O— group forming an ester functional group, carbonyl group, a primary amido group or secondary amido group, a primary amino group, a secondary amino group or tertiary amino group;
each R²⁹, R³⁰, R³² and R³³ is independently a straight chain alkyl group of from 1 to 6 carbon atoms or a branched chain alkyl group of from 3 to 6 carbon atoms;
each R³¹ is independently hydrogen, a straight chain alkyl group of from 1 to 10 carbon atoms, a branched chain alkyl group of from 3 to 10 carbon atoms, an aryl group of from 6 to 10 carbon atom or an aralkyl of from 7 to 10 carbon atoms; and
the subscript j is an integer from 1 to 5; and
(iii) a silicon compound containing a conjugated C═C group having the general formula (VIII):
A²Si(CH₃)ₖ(OR³⁵)₃₋ₖ (VIII)
wherein
A² is CH₂═C(CH₃)C(═O)OCH₂CH₂CH₂— or phenyl;
R³⁵ is independently a straight chain alkyl group of from 1 to 4 carbon atoms or a branched chain alkyl group of 3 or 4 carbon atoms; and
k is an integer 0 or 1; and
(c) an adhesion promoter containing an alkoxysilyl group; and
(d) a curing catalyst.

2. The moisture-curable silylated polymer composition of claim 1, wherein the adhesion promoter containing an alkoxysilyl group has the general formula (XVI):
A³[R³⁶—Si(CH₃)ₙ(OR³⁷)₃₋ₙ]ₒ (XVI)
wherein
A³ is a monovalent functional group selected from H₂N—, H₂NCH₂CH₂NH—, CH₃NH—, CH₃CH₂NH—, CH₃(CH₂)₂NH—, CH₃(CH₂)₃NH— and glycidoxy-, a divalent functional group —NH—, or a trivalent functional group, isocyanaurato-;
each R³⁶ is independently a straight chain alkylene group of from 1 to 6 carbon atoms or a branched chain alkylene group of from 3 to 6 carbon atoms;
each R³⁷ is independently a straight chain alkyl group of from 1 to 4 carbon atoms or a branched chain alkyl group of from 3 to 4 carbon atoms; and
the subscripts n and o are integers where n is 0 or 1 and o is 1, 2 or 3, with the provisos that when monovalent, o is 1, when A³ is divalent, o is 2 and when A³ is trivalent, o is 3.

3. The moisture-curable silylated polymer composition according to claim 1, wherein the adhesion promoter containing an alkoxysilyl group (c) is 3-aminopropyltrimethoxysilane, 3-aminopropyltriethoxysilane, N-(2-aminoethyl) aminopropyltrimethoxysilane, N-ethyl 3-amino-2-methylpropyltrimethoxysilane, bis-(trimethoxysilylpropyl) amine, N, N′, N″-tris-(3-trimethoxysilylpropyl)isocyanurate, N-(2-ethyl)3-aminopropylmethyl-dimethoxysilane, 3-glycidoxypropyltrimethoxysilane, 3-glycidoxypropyltriethoxysilane, or 3-glycidoxypropylmethyldiethoxysilane.

4. The moisture-curable silylated polymer composition according to claim 1, wherein the curing catalyst (d) is selected from the group consisting of organic dibutyltin, zirconium complex, aluminum chelate, titanic chelate, organic zinc, organic cobalt, organic iron, organic nickel and organobismuth, primary amine, secondary amine, tertiary amine and amino-functional alkoxysilane and mixtures thereof.

5. The moisture-curable silylated polymer composition according to claim 1, wherein the curing catalyst (d) is selected from the group consisting of tetra-tert-butyl orthotitanate, titanium(IV) bis(ethylacetoacetato)diisobutoxide, titanium(IV) bis(ethylacetoacetato)dimethoxide, titanium(IV) bis(ethylacetoacetato)diethoxide, titanium(IV) bis(ethylacetoacetato)monoethoxide monomethoxide, titanium(IV) bis(ethylacetoacetato)diisopropoxide, di-n-butyltin dilaurate, di-n-butyltin diacetate, di-n-butyltin oxide, di-n-butyltin dineodecanoate, di-n-butyltin diacetylacetonate, di-n-butyltin maleate, di-n-octyltin diacetate, di-n-octyltin dilaurate, di-n-octyltin oxide, di-n-octyltin maleate, di-n-octyltin di(2-ethyl)hexanoate, di-n-octyltin neodecanoate, di-n-octyltin isodecanoate, the partial hydrolysis products thereof of organic tin compounds, the partial hydrolysis products thereof of titanium compounds, and the reaction products of these organic tin compounds, titanium compounds, partial hydrolysis products of organic tin compounds or titanium compounds with tetraethoxysilane, methyltriethoxysilane, methyltrimethoxysilane, propyltrimethoxysilane, 3-aminopropyltrimethoxysilane, 3-aminopropyltriethoxysilane, 2-aminoethyl-3-aminopropyltrimethoxysilane, and 2-aminoethyl-3-aminopropyltrimethoxysilane.

6. The moisture-curable silylated polymer composition according to claim 1, wherein the light stabilizer (b)(i) is chosen from poly(oxy-1,2-ethanediyl), α-(3-(3-(2H-benzotriazol-2-yl)-5-(1,1-dimethylethyl)-4-hydroxyphenyl)-1-oxopropyl)-ω-hydroxy; poly(oxy-1,2-ethanediyl), α-(3-(3-(2H-benzotriazol-2-yl)-5-(1,1-dimethylethyl)-4-hydroxyphenyl)-1-oxopropyl-ω-(3-(3-(2H-benzotriazol-2-yl-5-(1,1-dimethylethyl)-4-hydroxyphenyl)-1-oxopropoxy); α-3-(3-(2H-benzotriazol-2-yl)-5-tert-butyl hydroxyphenyl)propionyl-ω-hydroxypoly(oxyethylene); α-3-(3-(2H-benzotriazol-2-yl)-5-tert-butyl-4-hydroxyphenyl)propionyl-ω-3-(3-(2H-benzotriazol-2-yl)-5-tert-butyl hydroxyphenyl)propionyloxypoly(oxyethylene); 2-(2′-hydroxy-5′-methylphenyl)-benzotriazole; 2-(3′,5′-di-tert-butyl-2′-hydroxyphenyl)-benzotriazole; 2-(5′-tert-butyl-2′-hydroxyphenyl)-benzotriazole; 2-(2′-hydroxy-5′-(1,1,3,3-tetramethylbutyl)-phenyl)-benzotriazole; 2-(3′,5′-di-tert-butyl-2′-hydroxyphenyl)-5-chlorobenzotriazole; 2-(3′-tert-butyl-2′-hydroxy-5′-methylphenyl) chlorobenzotriazole; 2-(3′-sec-butyl-5′-tert-butyl-2′-hydroxyphenyl)-benzotriazole; 2-(2′-hydroxy-4′-octyloxyphenyl)-benzotriazole; 2-(3′,5′-di-tert-amyl-2′-hydroxyphenyl)-benzotriazole; 2-(3′,5′-bis(α,α-dimethylbenzyl)-2′-hydroxyphenyl)-benzotriazole; 2-(3′-tert-butyl-2′-hydroxy-5′-(2-octyloxycarbonylethyl)phenyl)-5-chlorobenzotriazole; 2-(3′-tert-butyl-5′-[2-(2-ethylhexyloxy)carbonylethyl]-2′-hydroxyphenyl)-5-chlorobenzotriazole; 2-(3′-tert-butyl-2′-hydroxy-5′-(2-methoxycarbonylethyl)phenyl)-5-chlorobenzotriazole; 2-(3′-tert-butyl-2′-hydroxy-5′-(2-methoxycarbonylethyl)phenyl)-benzotriazole; 2-(3′-tert-butyl-2′-hydroxy-5′-(2-octyloxycarbonylethyl)phenyl)-benzo-triazole; 2-(3′-tert-butyl-5′-[2-(2-ethylhexyloxy)carbonylethyl]-2′-hydroxyphenylybenzotriazole; 2-(3′-dodecyl-2′-hydroxy-5′-methylphenyl)-benzotriazole; 2-(3′-tert-butyl-2′-hydroxy-5′-(2-isooctyloxycarbonylethyl)-phenyl-benzotriazole; 2,2′-methylenebis[4-(1,1,3,3-tetramethylbutyl)-6-benzotriazol-2-yl-phenol]; or combinations thereof.

7. The moisture-curable silylated polymer composition according to claim 1, wherein the light stabilizer (b)(i) is chosen from poly(oxy-1,2-ethanediyl), α-(3-(3-(2H-benzotriazol-2-yl)-5-(1,1-dimethylethyl)-4-hydroxyphenyl)-1-oxopropyl)-ω-hydroxy and poly(oxy-1,2-ethanediyl), α-(3-(3-(2H-benzotriazol-2-yl)-5-(1,1-dimethylethyl)-4-hydroxyphenyl)-1-oxopropyl-ω-(3-(3-(2H-benzotriazol-2-yl-5-(1,1-dimethylethyl)-4-hydroxyphenyl)-1-oxopropoxy); or α-3-(3-(2H-benzotriazol-2-yl)-5-tert-butyl-4-hydroxyphenyl)propionyl-ω-hydroxypoly(oxyethylene), α-3-(3-(2H-benzotriazol-2-yl)-5-tert-butyl-4-hydroxyphenyl)propionyl-ω-3-(3-(2H-benzotriazol-2-yl)-5-tert-butyl-4-hydroxyphenyl)propionyloxypoly(oxyethylene) and poly(oxy-1,2-ethanediyl), α-hydro-ω-hydroxy-ethane-1,2-diol, ethoxylated or mixtures thereof.

8. The moisture-curable silylated polymer composition according to claim 1, wherein the light stabilizer (b)(i) is N-(2-ethoxyphenyl)-N′-(2-ethylphenyl)ethylenediamide (CAS: 23949-66-8), N,N′-diphenylethylenediamide (CAS: 620-81-5), N-(5-(1,1-dimethylethyl)-2-ethoxyphenyl)-N′-(2-ethylphenyl)ethylenediamide (CAS: 35001-52-6) and N-(2-ethoxyphenyl)-N′-(4-isododecylphenyl)ethylenediamide (CAS: 82493-14-9), more particularly N-(2-ethoxyphenyl)-N′-(2-ethylphenyl)ethylenediamide (CAS: 23949-66-8) and N-(2-ethoxyphenyl)-N′-(4-isododecylphenyl)ethylenediamide (CAS: 82493-14-9) or mixtures thereof.

9. The moisture-curable silylated polymer composition according to claim 1, wherein the sterically hindered amine (b)(ii) is chosen from 3-(2,2,6,6-tetramethyl-piperidin-4-yloxy)-propionic acid, 4-(2,2,6,6-tetramethyl-piperidin-4-yl)-butyric acid, poly-[4-(2,2,6,6-tetramethyl-piperidin-4-yl)-butyric acid] ester, poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]], bis(2,2,6,6-tetramethyl-4-piperidyl)maleate, bis(2,2,6,6-tetraethyl-4-piperidyl)maleate, bis(2,2,6,6-tetramethyl-4-piperidyl)maleate, bis(2,2,6,6-tetrahexyl-4-piperidyl)sebacate, bis(1,2,2,6,6-pentamethyl-4-piperidinyl)-2-butyl-2-(4-hydroxy-3,5-di-tert-butylbenzyl)propanedioate, poly-[7-(4-hydroxy-2,2,6,6-tetramethyl-piperidin-1-yl)-4-oxo-heptanoic acid] ester, poly-[6-(4-hydroxy-2,2,6,6-tetraethyl-piperidin-1-yl)-hexanoic acid] ester, poly-[7-(4-hydroxy-2,2,6,6-tetramethyl-piperidin-1-yl)-4-oxo-heptanoic acid] ester, 7-(4-hydroxy-2,2,6,6-tetramethyl-piperidin-1-yl)-4-oxo-heptanoic acid 1-tert-butyl-2,2,6,6-tetramethyl-piperidin-4-yl ester, 7-(4-hydroxy-2,2,6,6-tetramethyl-piperidin-1-yl)-4-oxo-heptanoic acid, 8-(4-hydroxy-2,2,6,6-tetramethyl-piperidin-1-yl)-5-oxo-octanoic acid, 6-(4-hydroxy-2,2,6,6-tetramethyl-piperidin-1-yl)-hexanoic acid, 4-(4-hydroxy-2,2,6,6-tetramethyl-piperidin-1-yl)-benzoic acid, polymer resulting from the reaction of dimethylbutanedioate with 4-hydroxy-2,2,6,6-tetramethyl-1-piperidine ethanol, or mixtures thereof.

10. The moisture-curable silylated polymer composition according to claim 1, wherein the silicon compound containing a conjugated C═C group (b)(iii) is chosen from phenyltrimethoxysilane, phenylmethyldimethoxysilane, phenyltriethoxysilane, phenylmethyldiethoxysilane, diphenylmethylmethoxysilane, diphenylmethylethoxysilane, 3-methacryloxypropyltrimethoxysilane, 3-methacryloxypropyltriethoxysilane or 3-methacryloxypropylmethyldimethoxysilane.

11. The moisture-curable silylated polymer composition according to claim 1, wherein the silicon compound containing a conjugated C═C group (b)(iii) is phenyltrimethoxysilane.

12. The moisture-curable silylated polymer composition according to claim 1, wherein the silicon compound containing a conjugated C═C group (b)(iii) is 3-methacryloxypropyltrimethoxysilane.

13. The moisture-curable silylated polymer composition according to claim 1, where A is —O—, R¹ is methyl, R² is methyl, R³ propylene, R⁴ is hydrogen, methyl or ethyl, R⁵ is a divalent or polyvalent group having the general formula (II):
—R⁶O(R⁷O)_{d}(R⁸O)_{c-2}[C(═O)NH—R⁰—NHC(═O)O(R⁷O)_{d}]ₘR⁶— (II)
wherein each R⁶ is independently ethylene, 2-methylethylene or 1-methylethylene, R⁰ is hexylene or 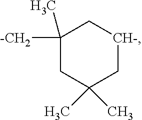
each R⁷ is independently ethylene, 2-methylethylene or 1-methylethylene, a is 0, b is 1, c is 2, d is from 20 to 400, e is from 0 to 100 and m is 0 or 1.

14. The moisture-curable silylated polymer composition according to claim 1, where the light stabilizer (b)(i) is present in an amount of from about 0.5 to about 3 parts by weight per 100 parts by weight of the alkoxysilyl-containing polymer (a).

15. The moisture-curable silylated polymer composition according to claim 1, where the sterically hindered amine (b)(ii) is present in an amount of from about 0.2 to about 1.5 parts by weight per 100 parts by weight of the alkoxysilyl-containing polymer (a).

16. The moisture-curable silylated polymer composition according to claim 1, where the silicon compound containing a conjugated C═C group (b)(iii) is present in an amount of from about 1.0 to about 5 parts by weight by weight per 100 parts by weight of the alkoxysilyl-containing polymer (a).

17. The moisture-curable silylated polymer composition according to claim 1, wherein the adhesion promoter (c) is present in an amount of from about 0.5 to about 5 parts by weight per 100 parts by weight of the alkoxysilyl-containing polymer (a).

18. The moisture-curable silylated polymer composition according to claim 1, wherein the curing catalyst (d) is present in an amount of from about 0.1 to about 3 parts by weight per 100 parts by weight of the alkoxysilyl-containing polymer (a).

19. The moisture-curable silylated polymer composition according to claim 1, wherein said polymer composition after curing has a percent non-yellowing value of from −30% to 5% a period of UV exposure under ISO 4892-2:2013 Annex B, Method B, cycle B7 of 7 days.

20. The moisture-curable silylated polymer composition according to claim 1, wherein said composition is cured.

21. A sealant comprising the moisture-curable silylated polymer composition according to claim 1.
